(19) United States
(12) Patent Application Publication
(10) Pub. No.: US 2014/0343815 A1
(43) Pub. Date: Nov. 20, 2014

(54) VEHICLE CONTROL SYSTEM

(71) Applicants: Keisuke Takeuchi, Susono-shi (JP); Toshio Tanahashi, Susono-shi (JP); Yoshimitsu Agata, Numadu-shi (JP); Tomohide Kawasaki, Mishima-shi (JP); Shin Noumura, Yamato-shi (JP)

(72) Inventors: Keisuke Takeuchi, Susono-shi (JP); Toshio Tanahashi, Susono-shi (JP); Yoshimitsu Agata, Numadu-shi (JP); Tomohide Kawasaki, Mishima-shi (JP); Shin Noumura, Yamato-shi (JP)

(73) Assignee: TOYOTA JIDOSHA KABUSHIKI KAISHA, Toyota-shi (JP)

(21) Appl. No.: 14/344,435

(22) PCT Filed: Sep. 13, 2011
(86) PCT No.: PCT/JP2011/070791

§ 371 Date: May 9, 2014

(51) Int. Cl. B60T 7/12

(52) U.S. Cl. CPC B60T 7/12
USPC 701/70

(57) ABSTRACT

A vehicle control system configured to estimate an index representing a driving condition of a vehicle and a driving preference of a driver based on acceleration of the vehicle, and to adjust a driving characteristics of the vehicle based on the index. The vehicle control system is comprised of a straight-line braking determining means configured to determine a fact that a braking operation of the vehicle is carried out under a condition that the vehicle travels in a straight line, and an operational disturbance reducing means that prevents or reduces an effect of a disturbance resulting from the straight-line braking of the vehicle on an adjustment of the driving characteristics of the vehicle.

### TECHNICAL FIELD

The present invention relates to a control system for a vehicle, which is configured to adjust characteristics of output, steering, suspension etc. of the vehicle according to driver's preference (or disposition). More specifically, the present invention relates to a vehicle control system configured to accurately determine or estimate driving preference of the driver derived from a disposition or a habit.

### BACKGROUND ART

Basically, control characteristics of driving force, steering, suspension etc. of the vehicle are designed unchangeably to specific characteristics. However, driving preference of a driver is not always constant. That is, the driving preference derived from a disposition or a habit is different with each driver. In addition, the vehicle is driven by different drivers, and a driving environment varies depending on a weather condition, a day-night difference, a road condition and so on. Therefore, it is preferable to adjust the driving performance of the vehicle according to need, or in accordance with the driving preference of the driver. To this end, the driving characteristic of the vehicle has been changed manually by the driver, or by altering a speed change map for controlling a transmission. Specifically, a control system configured to select a driving mode of the vehicle by a switching operation, from a sporty mode where agility of behavior of the vehicle is enhanced, a normal mode where the behavior of the vehicle is moderated in comparison with the sporty mode, and an economy mode where fuel economy is improved.

However, in case of using the above-explained control system, the driver is required to operate a switch every time to select the driving mode. Such switching operation may bother the driver, and the shifting operation of the drive mode may be delayed by thus operating the switch. In order to solve such a disadvantage, an attempt has been made to reflect an intention of the driver on a vehicle control by judging the intention of the driver from a behavior of the vehicle. For example, Japanese Patent Laid-Open No. 2009-530166 discloses a control apparatus configured to judge a driving style of a driver based on data representative of an acceleration of the vehicle. According to the teachings of Japanese Patent Laid-Open No. 2009-530166, at least one active subsystem in a chassis of a vehicle (e.g., a steering controller, a drive controller, a power train controller, a brake controller etc.) is controlled according to the driving style thus judged.

To this end, according to the teachings of Japanese Patent Laid-Open No. 2009-530166, a “surface utilization” is calculated to judge the driving style of the driver based on longitudinal and lateral accelerations of the vehicle. Specifically, the “surface utilization” is a synthesized acceleration of the longitudinal and lateral accelerations that is a sum of squares of the normalized longitudinal acceleration and the normalized lateral acceleration of the vehicle. The “surface utilization” is weighted with a weighted factor progressively related to a sped of the vehicle, and the driving style of the driver is judged based on the weighted “surface utilization”. Consequently, the operating mode of the vehicle is selected from any of the normal mode and the sport mode.

Thus, according to the teachings of Japanese Patent Laid-Open No. 2009-530166, the driving style of the driver is judged based on the acceleration of the vehicle, and the operating mode of the vehicle is selected from any of the normal mode and the sport mode according to the driving style. That is, the driving characteristic can be adjusted in accordance with the estimated driving preference of the driver. However, the control apparatus thus configured to estimate the driving preference of the driver based on the acceleration of the vehicle may have a following disadvantage. For example, when the vehicle travels on a bumpy road or a road having an uneven gradient, or when an abrupt braking or steering is carried out to dodge an obstacle, a component of the acceleration varied by such abrupt operation would be contained as a noise content in data for estimating the driving preference. Especially, if a braking operation is carried out under the situation that the vehicle travels in a straight line or runs at a high speed, such abrupt operation will effect significantly on the data for estimating the driving preference even if an operating amount is small. Consequently, greater noise content may be contained in the data in comparison with that resulting from an accelerating operation or a steering operation. Therefore, estimating accuracy of the driving preference of the driver may be deteriorated.

Thus, the conventional control system has to be improved to enhance the estimation accuracy of driving preference of the driver, and to reflect the intension or preference of the driver accurately on the adjustment of the driving characteristics of the vehicle.

### DISCLOSURE OF THE INVENTION

The present invention has been conceived noting the technical problems thus far described, and its object is to provide a vehicle control system configured to estimate a driving preference of a driver accurately, and to adjust driving characteristics of the vehicle while reflecting an intention or a preference of the driver on the driving characteristics.

In order to achieve the above-mentioned object, according to the present invention, there is provided a vehicle control system that is configured to estimate an index representing a driving condition of a vehicle and a driving preference of a driver based on acceleration of the vehicle, and to adjust a driving characteristics of the vehicle based on the index. The vehicle control system of the present invention is comprised of: a straight-line braking determining means configured to determine a fact that a braking operation of the vehicle is carried out under a condition that the vehicle travels in a straight line; and an operational disturbance reducing means that prevents or reduces an effect of a disturbance resulting from the straight-line braking of the vehicle on an adjustment of the driving characteristics of the vehicle.

The operational disturbance reducing means is configured to damp the operational disturbance resulting from the straight-line braking of the vehicle stronger in comparison with the disturbances resulting from an accelerating operation and a steering operation.

According to the present invention, the operational disturbance includes: a disturbance component contained in acceleration data of a case in which the straight-line braking is carried out; and/or disturbance components contained in the acceleration data of a case in which the accelerating operation is carried out, and contained in the acceleration data of a case in which the steering operation is carried out.

The operational disturbance reducing means is configured to inhibit the control for changing the driving characteristics of the vehicle when the straight-line braking of the vehicle is carried out.

The vehicle control system is further comprised of a calculation means configured to calculate a jerk as a temporal differential value of the acceleration. The operational disturbance reducing means is configured to inhibit the control for changing the driving characteristics of the vehicle while the jerk exceeds a predetermined inhibition threshold.

According to the present invention, specifically, the acceleration includes a longitudinal acceleration of the vehicle and a lateral acceleration of the vehicle. In turn, the condition that the vehicle travels in a straight line includes a condition that the vehicle travels in a substantially straight line and that the lateral acceleration is within a predetermined range including zero. Therefore, the straight-line braking determining means is allowed to determine a fact that the straight-line braking operation is carried out based on the longitudinal acceleration and the lateral acceleration.

The vehicle control system is further comprised of a steering angle detecting means that detects a steering angle of the vehicle, and a braking operation detecting means that detects a fact that the braking operation of the vehicle is carried out. As described, the condition that the vehicle travels in a straight line includes the condition that the vehicle travels in a substantially straight line and that the lateral acceleration is within the predetermined range including zero. Therefore, the straight-line braking determining means is allowed to determine a fact that the straight-line braking operation is carried out based on the steering angle and the fact that the braking operation is carried out

According to another aspect of the present invention, the vehicle control system is configured to carry out a disturbance reducing control for preventing or reducing an effect of an operational disturbance resulting from a braking operation of the vehicle on an adjustment of the driving characteristics of the vehicle, in case the braking operation is carried out under a condition that a lateral acceleration resulting from a steering operation of the vehicle is within a predetermined range that will not effect on the adjustment of the driving characteristics so that the vehicle travels in a substantially straight line, and to inhibit the control for changing the driving characteristics of the vehicle while the braking operation is carried out under the condition that the vehicle travels in the straight line so that the disturbance reducing control is carried out.

Thus, according to the present invention, the vehicle control system is configured to detect or determine the straight-line braking carried out under the condition that the vehicle travels in a straight line, and if the straight line braking of the vehicle is determined, an effect of a disturbance resulting from the straight-line braking on an adjustment of the driving characteristics of the vehicle is reduced. If a braking force is applied to the vehicle travelling in a straight line, the control for changing or adjusting the driving characteristics of the vehicle is disturbed strongly by such a braking operation in comparison with a case of accelerating or steering the vehicle. In order to avoid such a disadvantage, the vehicle control system of the present invention is configured to reduce the effect of such an operational disturbance resulting from the straight-line braking. Therefore, the control for adjusting the driving characteristics of the vehicle will not be effected by the operational disturbance resulting from the straight-line braking. That is, the driving characteristics of the vehicle will not be changed against the driver's intension. Thus, the control for changing or adjusting the driving characteristics of the vehicle can be carried out properly while reflecting the driving preference or intension of the driver accurately.

According to the present invention, specifically, the operational disturbance resulting from commencing the straight-line braking is damped strongly by the filtering process. Therefore, the driving characteristics of the vehicle can be prevented certainly from being changed against the driver's intension even if the straight-braking is carried out.

When the straight-line braking is carried out, a disturbance component such as a noise content may be contained in the acceleration data. Therefore, in order to reduce the effects of such disturbance component, the vehicle control system of the present invention removes the disturbance components contained in the data of the acceleration resulting from an accelerating operation, and the data of the deceleration resulting from a braking operation, and the data of the lateral acceleration, and the disturbance component resulting from the braking operation is removed especially strongly. Alternatively, the disturbance component contained in the data of the acceleration resulting from commencing the straight-line braking is damped especially strongly. Therefore, accuracy for estimating the driving preference of the driver can be improved.

As described, the vehicle control system of the present invention is configured to inhibit the control for changing or adjusting the driving characteristics of the vehicle when the straight-line braking of the vehicle is commenced. Therefore, the driving characteristics of the vehicle can be prevented certainly from being changed against the driver's intension even if the straight-braking is carried out.

As also described, a jerk as a temporal differential value of the acceleration is calculated when the straight-line braking of the vehicle is commenced, and the control for changing the driving characteristics of the vehicle is inhibited while the jerk exceeds an inhibition threshold as a smallest value of the jerk to disturb the control for changing the driving characteristics. Therefore, the driving characteristics of the vehicle can be prevented certainly from being changed against the driver's intension even if the straight-braking is carried out.

According to the present invention, an execution of the straight-line braking is determined based on the detected longitudinal acceleration and lateral acceleration of the vehicle. Therefore, it is possible to determine the straight-line braking properly.

Alternatively, the straight-line braking may also be determined based on the detected steering angle of the vehicle and the braking operation. Therefore, it is possible to determine the straight-line braking properly.

### BRIEF DESCRIPTION OF THE DRAWINGS

FIG. 1 is a view schematically showing a vehicle to which the present invention is applied.

FIG. 2 is a friction circle plotting detected value of longitudinal acceleration and lateral acceleration.

FIG. 3 is a graph indicating an example of a change in the command SPI according to a change in an instant SPI.

FIG. 4 is a time chart indicating the integral of the deviation between the command SPI and the instant SPI, and a reset of the integral.

FIG. 5 is a block diagram showing procedures of filtering processes carried out by a noise filtering means for each acceleration detected to obtain the command SPI.

FIG. 6 is a block diagram showing remaining procedures of the filtering processes shown in FIG. 5 carried out by a noise filtering means for each acceleration detected to obtain the command SPI.

FIG. 7 is an example of a map used in the filtering process shown in FIG. 5 to determine a time constant of a transfer function.

FIG. 8 is a flowchart explaining a control example to be carried out by the vehicle control system of the present invention.

FIG. 9 is a flowchart explaining a modified example of a judgment of a straight-line braking to be carried out by the vehicle control system of the present invention.

FIG. 10 is a flowchart explaining another modified example of a judgment of a straight-line braking to be carried out by the vehicle control system of the present invention.

FIG. 11 is a flowchart explaining another control example to be carried out by the vehicle control system of the present invention.

### BEST MODE FOR CARRYING OUT THE INVENTION

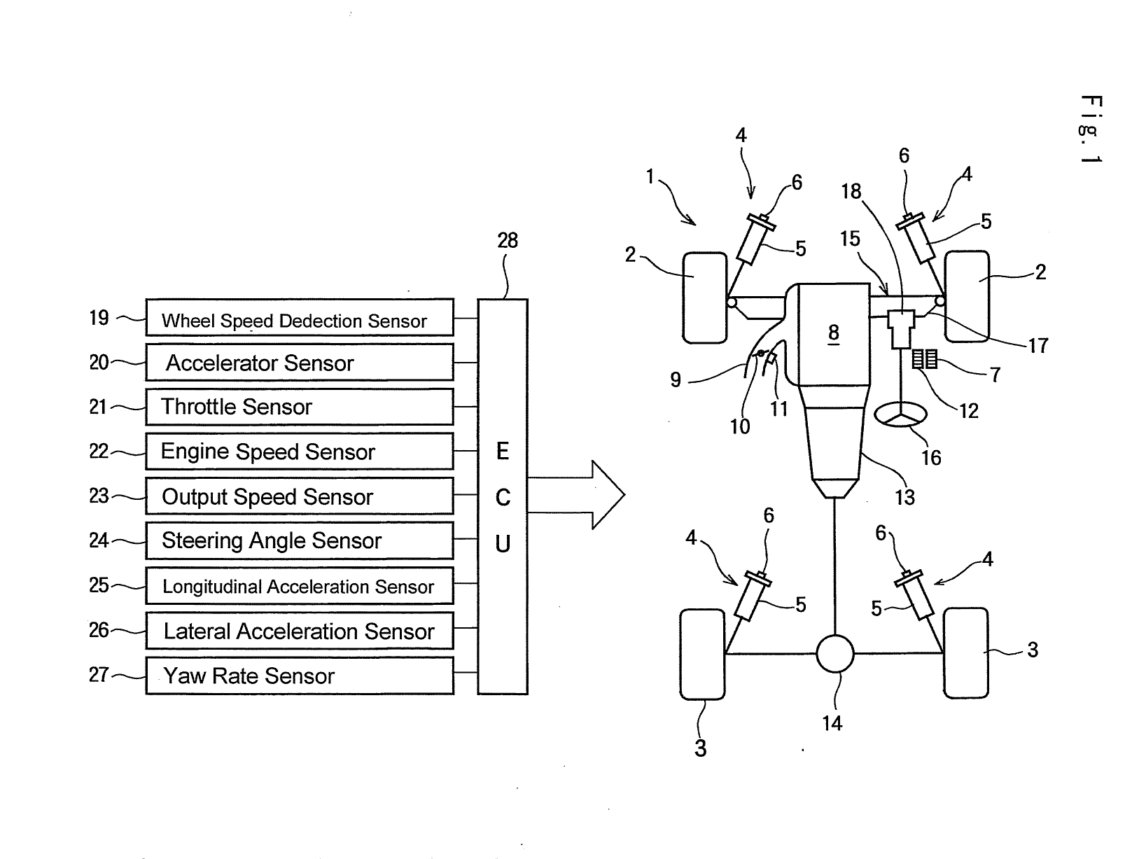

Next, the present invention will be explained in more detail. For example, the vehicle control system according to the present invention may be applied to a vehicle 1 shown in FIG. 1. In the vehicle 1, an output of a prime mover such as an engine or a motor, a speed change operation for changing a speed and a driving force of the prime mover, a steering, and a suspension mechanism sustaining the vehicle and so on can be controlled electrically. As shown in FIG. 1, the vehicle 1 is provided with a pair of front wheels 2 and a pair of rear wheels 3. Specifically, each of the front wheel 2 serve as a steering wheel, and each of the rear wheel 3 serves as a driven wheel. Those wheels 2 and 3 are individually attached to a not shown vehicle body via a suspension 4.

The suspension 4 is a conventional suspension device comprised of a not shown spring and a shock absorber (i.e., a damper) 5. The shock absorber 5 shown in FIG. 1 is configured to absorb a shock utilizing a flow resistance of air or liquid, and the flow resistance therein can be increased and decreased by a motor 6 serving as an actuator. For example, in case of increasing the flow resistance in the shock absorber 5, a hardness of the suspension 4 is enhanced so that the vehicle 1 becomes difficult to be depressed. As a result, the drive feeling of the vehicle 1 becomes much sporty rather than comfortable. In addition, a height of the vehicle 1 can be adjusted by adjusting pressurized air in the shock absorber 5.

Although not especially shown in FIG. 1, the front and rear wheels 2 and 3 are provided individually with a brake mechanism. Those brake mechanisms are actuated to apply a braking force to the wheels 2 and 3 by depressing a brake pedal 7 arranged in a driver seat.

A conventional internal combustion engine, a motor, a combination of the engine and the motor and so on may be used as a prime mover of the vehicle 1, and in the example shown in FIG. 1, an internal combustion engine 8 is used as the prime mover. As shown in FIG. 1, a throttle valve 10 for controlling air intake is arranged in an intake pipe 9 of the engine 8. Specifically, the throttle valve 10 is an electronic throttle valve that is opened and closed by an actuator 11 such as a motor controlled electrically, and an opening degree of the throttle valve 11 is also controlled by the actuator 11. The actuator 11 is actuated in accordance with a depression of an accelerator pedal 12 arranged in the driver seat, that is, in accordance with an opening degree of an accelerator, thereby adjusting an opening degree of the throttle valve 10 to a predetermined angle.

A relation between an opening degree of the accelerator and an opening degree of the throttle valve 10 may be adjusted arbitrarily, and if a ratio of the opening degree of the accelerator to the opening degree of the throttle valve 10 is approximately one to one, the throttle valve 10 reacts directly to the operation of the accelerator so that the sportiness of the vehicle 1 is enhanced. By contrast, in case of reducing the opening degree of the throttle valve 10 relatively with respect to the opening degree of the accelerator, the drive feeling of the vehicle 1 is moderated. In case of using the motor as the prime mover, a current control device such as an inverter or a converter is used instead of the throttle valve 10. In this case, a relation between the opening degree of the accelerator and a current value, that is, the drive feeling of the vehicle 1 is changed arbitrarily by adjusting the current in accordance with the opening degree of the accelerator by the current control device.

A transmission 13 is connected with an output side of the engine 8. The transmission 13 is adapted to change a speed ratio between an input speed and an output speed arbitrarily. For example, a conventional automatic geared transmission, a belt-type continuously variable transmission, a toroidal type transmission may be used as the transmission 13. Specifically, the transmission 13 is provided with a not shown actuator, and configured to change the speed ratio thereof stepwise or continuously by controlling the actuator.

Basically, the transmission 13 is controlled in a manner to optimize the speed ratio to improve fuel economy. For this purpose, a speed change map for determining the speed ratio according to a speed of the vehicle 1 and the opening degree of the accelerator is preinstalled, and the speed change operation of the transmission 13 is carried out with reference to the map. Alternatively, the speed ratio of the transmission 13 is optimized by calculating a target output on the basis of the speed of the vehicle 1 and the opening degree of the accelerator, calculating a target engine speed on the basis of the calculated target output and an optimum fuel curve, and carrying out a speed change operation to achieve the obtained target engine speed.

A driving mode of the vehicle 1 to which the vehicle control system according to the present invention is applied can be selected from a fuel saving mode for reducing fuel consumption and a power mode for increasing a driving force. Specifically, under the fuel saving mode, an upshifting is carried out at a relatively low speed, and the speed ratio is kept to a relatively small ratio even in case the vehicle is driven at a low speed. To the contrary, under the power mode, the upshifting is carried out at a relatively high speed, and the speed ratio is kept to a relatively large ratio even in case the vehicle is driven at a high speed thereby increasing the driving force and enhancing acceleration. Those speed controls are carried out by switching the speed change map while correcting the drive demand or the calculated speed ratio.

In addition, a transmission mechanism such as a torque converter having a lockup clutch may be arranged between the engine 8 and the transmission 13 according to need. An output shaft of the transmission 13 is connected with the rear wheels 3 via a differential gear 14 used as a final reducing mechanism.

Here will be explained a steering mechanism 15 for changing an orientation of the front wheels 2. The steering mechanism 15 comprises: a steering wheel 16; a steering linkage 17 adapted to transmit a rotation of the steering wheel 16 to the front wheels 2; and an assist mechanism 18 adapted to assist a steering angle and a steering force of the steering wheel 16. The assist mechanism 18 is provided with a not shown actuator, and adapted to control an assisting amount of the actuator. Therefore, a ratio of the steering angle of the steering wheel 16 to an actual steering angle of the front wheels 2 can be approximated to one to one by reducing the assisting force of the assist mechanism 18. As a result, the front wheels 2 can be turned directly in response to the rotation of the steering wheel 16 so that the sportiness of the vehicle 1 is enhanced.

Although not especially shown, in order to stabilize a behavior and attitude of the vehicle 1, the vehicle 1 is further provided with an antilock brake system (abbreviated as ABS), a traction control system, and a vehicle stability control system (abbreviated as VSC) for controlling those systems integrally. Those systems are known in the art, and adapted to stabilize the behavior of the vehicle 1 by preventing a locking and slippage of the wheels 2 and 3. For this purpose, those systems are configured to control a braking force applied to the wheels 2 and 3 on the basis of a deviation between a vehicle speed and a wheel speed while controlling the engine torque. In addition, the vehicle 1 may be provided with a navigation system for obtaining data on road information and a contemplated route (i.e., data on driving environment), and a mode selecting switch for selecting a drive mode manually from a sporty mode, a normal mode, an energy saving mode (i.e., economy mode) and so on. Further, a 4-wheel-drive mechanism (4WD) adapted to change the driving characteristics such as a hill-climbing ability, acceleration, a turning ability and so on may be arranged in the vehicle 1.

In order to obtain data for controlling the engine 8, the transmission 13, the shock absorber 5 of the suspension 4, the assist mechanism 18, and the above-explained not shown systems, various kinds of sensors are arranged in the vehicle 1. For example, a wheel speed detection sensor 19 adapted to detect a rotational speed of each wheel 2 and 3, an accelerator sensor 20 adapted to detect an opening degree of the accelerator, a throttle sensor 21 adapted to detect an opening degree of the throttle valve 10, an engine speed sensor 22 adapted to detect a speed of the engine 8, an output speed sensor 23 adapted to detect an output speed of the transmission 13, a steering angle sensor 24, a longitudinal acceleration sensor 25 adapted to detect the longitudinal acceleration Gx, a lateral acceleration sensor 26 adapted to detect the lateral (or transverse) acceleration Gy, a yaw rate sensor 27 and so on are arranged in the vehicle 1. Here, acceleration sensors used in the above-explained behavior control systems such as the antilock brake system (ABS) and a vehicle stability control system (VSC) may be used as the acceleration sensors 25 and 26, and if an air-bag is arranged in the vehicle 1, acceleration sensors for controlling an actuation of the air-bag may also be used as the acceleration sensors 25 and 26.

Detection signals (i.e., data) of those sensors 19 to 27 are transmitted to an electronic control unit (abbreviated as ECU) 28. The ECU 28 is configured to carry out a calculation on the basis of the data inputted thereto and data and preinstalled programs, and to output a calculation result to the above-explained systems or the actuators thereof in the form of a control command signal.

The vehicle control system according to the present invention is configured to reflect the driving state of the vehicle 1 on the behavior control of the vehicle 1. Specifically, the driving state includes the longitudinal acceleration Gx, the lateral acceleration Gy, yawing acceleration, rolling acceleration, and a synthesized acceleration composed of a plurality of components of acceleration in different directions. Basically, in case of driving the vehicle 1 at a desired speed in a desired direction, or in case of adjusting a behavior of the vehicle 1 to a desired behavior in accordance with the driving environment such as a road surface, the vehicle 1 is accelerated in a plurality of directions. This means that the driving state of the vehicle 1 reflects the driving environment and a driving preference of the driver to some extent. For this reason, according to the present invention, the vehicle control system is configured to reflect the driving state of the vehicle on the behavior control of the vehicle 1.

The acceleration in any direction or the synthesized acceleration thus representing the driving state of the vehicle 1 may be reflected on the behavior control of the vehicle 1 without being processed to adjust the driving characteristics of the vehicle 1. However, in order to reflect the driving environment and the driving preference of the driver more accurately, the vehicle control system of the present invention is configured to correct or process the value of the acceleration to calculate the index.

To this end, first of all, the vehicle control system calculates an instant sportiness index (as will be abbreviated an instant SPI) representing a synthesized acceleration of the vehicle 1. Specifically, the instant SPI is calculated based on the longitudinal acceleration Gx and the lateral acceleration Gy, as expressed by the following formula:

Instant SPI=(Gx²+Gy²)^{1/2}.

At least one of positive acceleration and negative acceleration (i.e., deceleration) of the longitudinal acceleration Gx may be normalized or weighted to be used in the above formula. In case of driving the vehicle, an actual negative acceleration is larger than an actual positive acceleration. However, the driver cannot sense such difference between the actual negative acceleration and the actual positive acceleration in most cases. That is, the driver is basically unable to recognize the difference between the actual negative acceleration and the actual positive acceleration. Therefore, in order to correct a gap between the actual acceleration value and the acceleration recognized by the driver, the longitudinal acceleration Gx may be normalized by increasing the detected or calculated value of the positive acceleration, or by reducing the detected or calculated value negative acceleration (i.e., deceleration). Specifically, such normalization may be carried out by obtaining a ratio between maximum detected or calculated values of the positive acceleration and the negative acceleration, and multiplying the obtained ratio by the detected or calculated value of the positive or negative acceleration.

Alternatively, a detected or calculated value of the negative acceleration or the positive acceleration may be weighted to correct the gap. For example, a longitudinal driving force and a lateral force generated by a tire can be indicated in a friction circle. Likewise, those normalization or weighting is a process to maintain maximum accelerations in each direction within a circle of predetermined radius by weighting at least one of the positive and negative acceleration values. As a result of such normalization and weighting, an influence of the positive acceleration and an influence of the negative acceleration on the control to change the driving characteristics of the vehicle are differentiated. For example, the positive acceleration value and the negative acceleration value of the longitudinal acceleration Gx are weighted in a manner to increase the influence of the positive acceleration on the control to change the driving characteristics of the vehicle in comparison with that of the negative acceleration.

Thus, a degree of the gap between the actual acceleration value and the acceleration sensed by the driver is different depending on the direction of the acceleration. For example, the degree of the gap between the actual acceleration value and the acceleration sensed by the driver in the yawing direction of the vehicle is different from that in the rolling direction of the vehicle. Therefore, according to the vehicle control system of the present invention, a degree to reflect the acceleration on the control to change the driving characteristics of the vehicle, in other words, a degree to change the driving characteristics of the vehicle according to the acceleration can be differentiated depending on the direction of the acceleration.

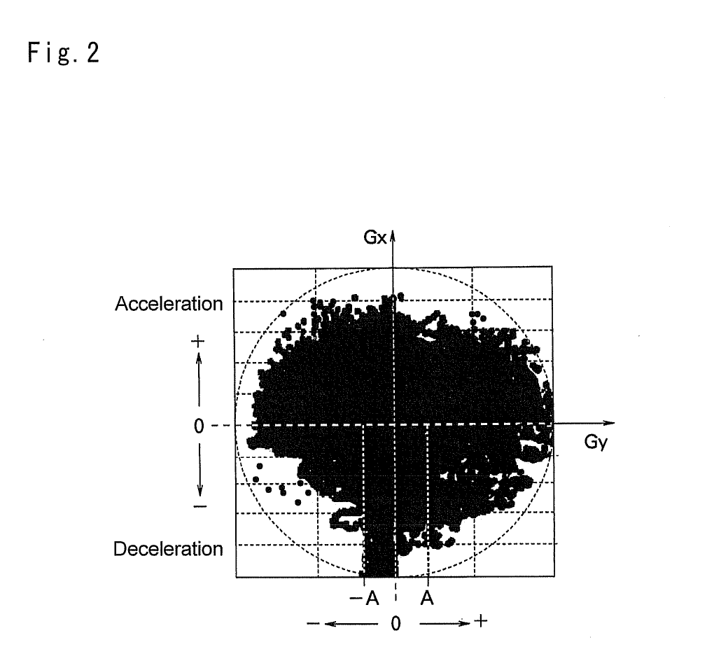

FIG. 2 is a friction circle plotting sensor values of the lateral acceleration Gy and normalized values of the longitudinal acceleration Gx. Those values indicated in FIG. 2 were collected by driving the vehicle in a test course imitating ordinary roads. As can be seen from FIG. 2, the lateral acceleration Gy also tends to be increased in case of decelerating the vehicle significantly, and both of the longitudinal acceleration Gx and the lateral acceleration Gy are generated generally within the friction circle.

As described, the longitudinal acceleration Gx includes acceleration resulting from increasing the driving force by depressing the accelerator pedal 12, and deceleration resulting from increasing the braking force by depressing the brake pedal 7. Thus, the deceleration is changed according to a depressing force for depressing the brake pedal 7. However, as described, the opening degree of the accelerator is electrically converted into the opening degree of the throttle valve 10. Therefore, although the acceleration is increased by depressing the accelerator pedal 12 to increase the engine output, degree of acceleration is changed depending on a characteristic of the output control, that is, depending on a relation between the opening degree of the accelerator and the opening degree of the throttle valve 10 or the engine torque. In addition, since the driving force is also changed by the speed ratio, the degree of acceleration is also changed depending on the characteristic of the speed change control. Further, when the vehicle 1 is running, the steering operation is carried out not only in case of changing a travelling direction but also in various situations, e.g., in case of avoiding an obstacle or a bump on the road surface. That is, the longitudinal acceleration Gx and the lateral acceleration Gy are varied not only by an intentional operation to change the driving condition but also by a temporal operation to avoid a danger, regardless of the driver's intention to maintain the current driving condition.

Therefore, in order to estimate or judge an essential behavior of the vehicle 1 or the intention of the driver accurately while removing disturbance factor such as a temporal change in the acceleration, it is preferable to calculate a command index for judging the vehicle behavior and the driver's intention while processing the instant SPI. An example of obtain the command index will be explained hereinafter. Specifically, the instant SPI is obtained successively based on the longitudinal acceleration Gx and the lateral acceleration Gy or the synthesized acceleration of Gx and Gy indicated in a friction circle shown in FIG. 2.

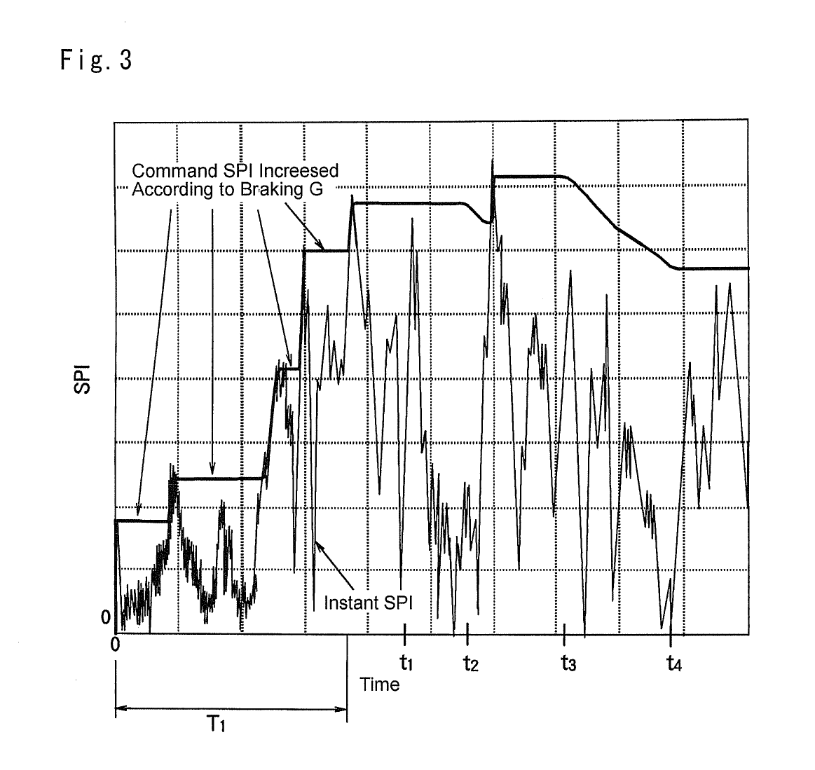

An example of a change in the instant SPI is indicated in FIG. 3. Specifically, the instant SPI is a sensor value obtained by differentiating an acceleration value detected by the acceleration sensor 25 and 26, or by differentiating a detection value of the wheel speed sensor 19. Therefore, the instant SPI may not be stabilized and always fluctuating instantaneously. As described, such fluctuation of the instant SPI is caused by some sort of factors regardless of the driver's intention. Therefore, the command index (as will be called a command SPI hereinafter) is determined to judge a driving preference of the driver. Specifically, the command SPI is set to a local maximum value of the instant SPI, and held until the instant SPI is increased to the larger local maximum value (than the current command SPI being held). When the instant SPI is thus increased to the larger local maximum value, the command SPI is updated to the larger local maximum value of the instant SPI and held thereto. The command SPI thus being held is lowered in case the instant SPI fluctuating below the local maximum value thereof satisfies a predetermined condition.

The command SPI thus determined is indicated by a heavy line in FIG. 3. As can be seen from FIG. 3, the command SPI calculated based on the instant SPI is increased immediately with an increase of the instant SPI, but lowered after a delay with respect to a drop of the instant SPI. As described, the command SPI is lowered based on a satisfaction of a specific condition. Specifically, the instant SPI shown in FIG. 3 corresponds to the plotted values indicated in FIG. 2. Meanwhile, the command SPI is set on the basis of the local maximum value of the instant SPI, and the command SPI is maintained thereto until a satisfaction of a predetermined condition. Thus, the command SPI is increased promptly but lowered relatively slower.

Specifically, during a period T1 from a commencement of the control, the instant SPI based on the acceleration of the vehicle is fluctuated according to a change in the acceleration. As shown in FIG. 3, the instant SPI being fluctuated is increased locally to a maximum value prior to a satisfaction of the predetermined condition to update the command SPI. In this situation, the command SPI is set on the basis of each local maximum value of the instant SPI. Therefore, the command SPI is increased stepwise during the period T1. Then, when the condition to lower the command SPI is satisfied at a time point t2 or t3, the command SPI is started to be lowered. That is, the command SPI is lowered in case that maintaining the previous large value of the command SPI is presumed not to be preferable. Specifically, according to the present invention, such condition to lower the command SPI is satisfied according to elapsed time.

More specifically, the above-mentioned condition in which “maintaining the previous large value of the command s SPI is presumed not to be preferable” is a situation in which a divergence between the command SPI being maintained to the current value and the current instant SPI is relatively large and such divergence between those indexes is being continued. That is, the command SPI will not be lowered, in other words, the condition to lower the command SPI will not be satisfied even if the instant SPI is lowered by an unintentional deceleration. For example, the command SPI will not be lowered in case the accelerator pedal 12 is returned temporarily by a habit of the driver, or to maintain the vehicle speed after accelerating the vehicle. However, if the instant SPI fluctuates below the command SPI for a certain period of time, the aforementioned condition to lower the command SPI is satisfied.

Thus, the length of time in which the instant SPI stays below the command SPI may be used as the condition to lower the command SPI. In order to reflect the actual driving condition of the vehicle more accurately on the command SPI, a temporal integration (or accumulation) of the deviation between the command SPI being maintained and the instant SPI may be used as the condition to lower the command SPI. In this case, the command SPI is lowered when the temporal integration of the deviation between those indexes reaches a predetermined threshold value. For this purpose, this threshold value may be determined arbitrarily on the basis of a driving test or simulation. In case of using the temporal integration as the condition to lower the command SPI, the command SPI is to be lowered taking into consideration a duration time of the divergence of the instant SPI from the command SPI, in addition to the deviation between the command SPI and the instant SPI. In this case, therefore, the actual driving condition or behavior of the vehicle can be reflected on the control to change the driving characteristics more accurately.

In the example shown in FIG. 3, a length of time to maintain the command SPI before the time point t2 is longer than a length of time to maintain the command SPI before the time point t3. Those lengths of times to maintain the command SPI are determined by a control to be explained hereinafter. Specifically, as indicated in FIG. 3, the command SPI is increased to a predetermined value at the end of the aforementioned period T1 and maintained. In this situation, the instant SPI rises instantaneously at the time point t1, before the condition to lower the command SPI is to be satisfied at the time point t2. Therefore, the deviation between the command SPI and the instant SPI in this situation is smaller than a predetermined value, and the command SPI is therefore maintained to the time point t2. Here, this predetermined value to lower the command SPI may be determined arbitrarily on the basis of a driving test or simulation while taking into consideration a calculation error of the instant SPI. In case the instant SPI is thus raised close to the command SPI, this means that the actual driving condition of the vehicle is similar to the accelerating and turning conditions upon which the current command SPI being maintained is based. That is, although a certain period of time has elapsed from the time point at which the current commend SPI being held was set, the actual driving condition of the vehicle is still similar to the condition at the time point when the current command SPI being maintained was set. In this situation, therefore, a commencement to lower the command SPI is delayed even if the instant SPI is fluctuating below the current command SPI being maintained. Thus, the length of time to hold the command SPI varies depending on the situation.

For example, the commencement to lower the command SPI can be delayed by resetting the elapsed time (i.e., accumulation time) or the integral of deviation from the time point at which the current command SPI was set, and restarting the accumulation of the elapsed time or the integration of the deviation. Alternatively, the commencement to lower the command SPI may also be delayed by subtracting a predetermined value from the elapsed time of the command SPI or the integral of deviation between the indexes, or interrupting the accumulation of the elapsed time or the integration of the deviation for a predetermined period of time.

In addition, in the example shown in FIG. 3, the command SPI is maintained to a constant value after the time point t4. This is because an unexpected situation is excluded from being considered as a change in the driving condition, after the time point t4. Specifically, the unexpected situation can be exemplified by an execution of a temporal decelerating or steering operation to avoid a road obstacle. The instant SPI is lowered significantly by such a temporal operation. However, such depression of the instant SPI is only a temporal change and it should not be considered as a demand of the driver to change the characteristic of the vehicle behavior. That is, in case such a temporal operation is carried out, it is rather preferable to maintain the current characteristic of the vehicle behavior to achieve a drive feeling expected by the driver. In this case, therefore, the current command SPI is maintained.

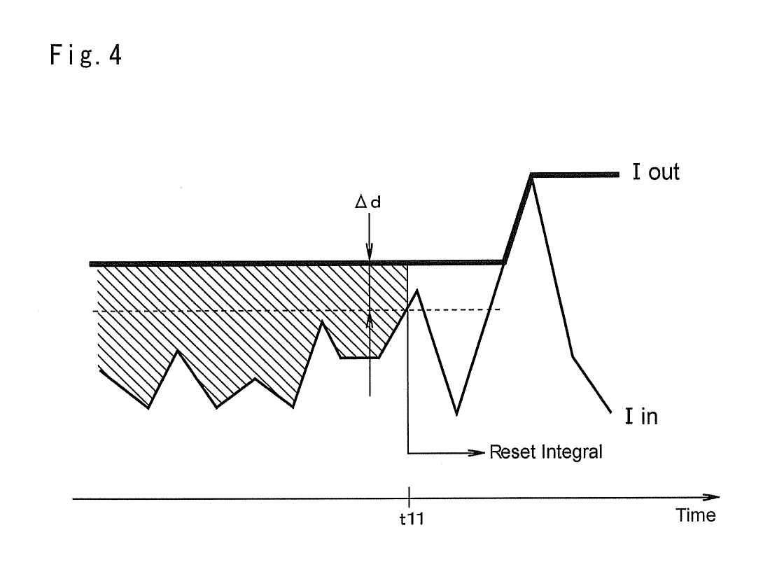

FIG. 4 is a time chart indicating the aforementioned integral of the deviation between the command SPI and the instant SPI, and a timing to carry out a reset of the integral. In FIG. 4, a shadowed area corresponds to the integral of the deviation between the command SPI and the instant SPI. In the example indicated in FIG. 4, the reset of the integral of the deviation is executed at a time point t11 at which the divergence between the command SPI and the instant SPI becomes smaller than a predetermined value Δd, and the integration of the deviation between those indexes is restarted from the time point t1. Consequently, the condition to lower the command SPI is prevented from being satisfied at the time point t11 so that the command SPI is maintained to the previous value. Then, when the instant SPI exceeds the command SPI after restarting the integration of the deviation between those indexes, the command SPI is updated to the local maximum value of the instant SPI. The command SPI thus updated is to be maintained and the integration of the deviation between those indexes is reset again.

In case of thus judging the satisfaction of the condition to lower the command SPI on the basis of the integral of the deviation between the command SPI and the instant SPI, a degree or gradient to lower the command SPI may be changed depending on the situation. As explained, the aforementioned integral is a time integral of the deviation between the command SPI being maintained and the instant SPI. Therefore, in case the deviation between the command SPI and the instant SPI is large, the integral of the deviation between those indexes reaches the predetermined value promptly so that the aforementioned condition to lower the command SPI is satisfied in a relatively short time. To the contrary, in case the deviation between the command SPI and the instant SPI is small, the integral of the deviation between those indexes reaches the predetermined value in a relatively long time. In this case, therefore, it will take relatively long time to satisfy the aforementioned condition to lower the command SPI.

For example, the degree or gradient to lower the command SPI may be differentiated depending on a length of time elapses before a satisfaction of the condition to lower the command SPI. Specifically, in case the condition to lower the command SPI is satisfied in a short time, the instant SPI falls significantly from the current command SPI being maintained. This means that the current command SPI is deviated away from the driver's current intention. In this case, therefore, the command SPI is lowered at a greater rate or steeper gradient. By contrast, in case it takes relatively long time to satisfy the condition to lower the command SPI, a difference between the command SPI being maintained and the instant SPI fluctuating below the command SPI is small. This means that the current command SPI being maintained is not deviated from the driver's intention significantly. In this case, therefore, the command SPI is lowered at a smaller rate or gentle gradient. For this reason, a gap between the command SPI for setting the driving characteristics of the vehicle and the driver's intention can be corrected rapidly and accurately so that the driving characteristics of the vehicle 1 can be adjusted to the actual driving condition.

Thus, the vehicle control system of the present invention is configured to adjust the driving characteristics of the vehicle 1 in accordance with the driving environment and the driver's intension thereby improving the drivability of the vehicle. However, when an unintentional operation is carried out by the driver, or when the vehicle travels on a bumpy road or a steeply sloping road, the synthesized acceleration of the vehicle is fluctuated instantaneously. Such fluctuation in the acceleration may be contained as a noise content or a disturbance component in the data for estimating the driving preference of the driver based on the synthesized acceleration of the vehicle 1. Consequently, an accuracy of estimating the driving preference may be deteriorated and the command SPI may not be determined properly.

In order to avoid the above-explained disadvantage, the vehicle control system of the present invention is configured to remove the noise content and disturbance component resulting from an unintentional operation of the driver when calculating the instant SPI on which the command SPI is based. Specifically, the vehicle control system is configured to carry out a filtering of a sensor value of the acceleration or a calculation value of the acceleration that is normalized based on the sensor value, and to calculate the instant SPI based on the filtered synthesized acceleration.

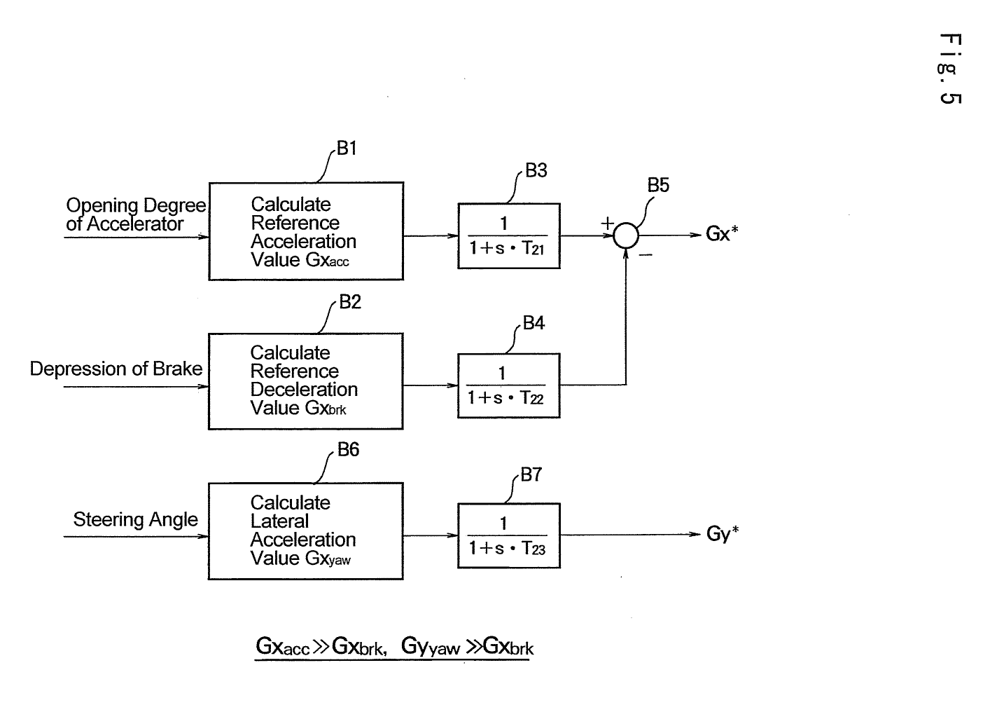

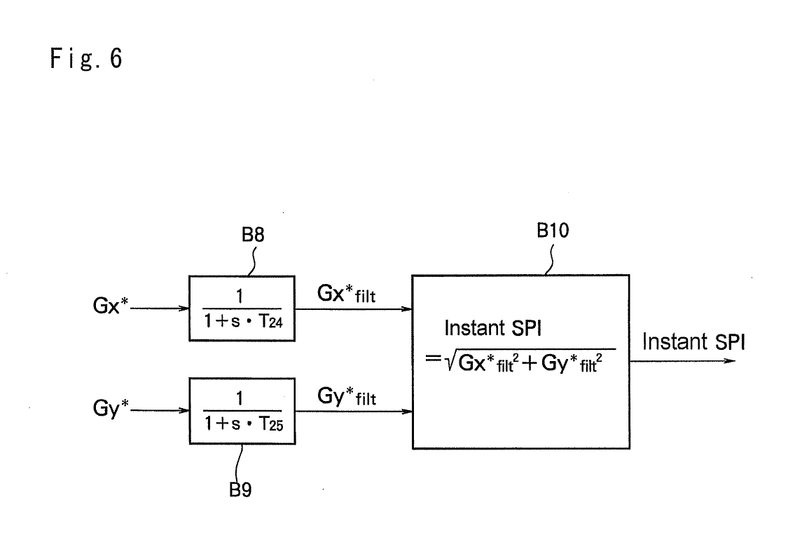

Referring now to FIGS. 5 and 6, a diagram showing procedures of calculating the instant SPI is shown. First of all, a reference acceleration value Gx_{acc} is calculated based on an operating amount of the accelerator pedal 12 (i.e., an opening degree of the accelerator) (Block B1). The reference acceleration value Gx_{acc} is to be used as a reference static longitudinal acceleration at the after-mentioned filtering process. Likewise, a reference deceleration value Gx_{brk} is calculated based on an operating amount (i.e., a depression) of the brake pedal 7 (Block B2). The reference deceleration value Gx_{brk} is to be used as a reference value of the static longitudinal deceleration (i.e., a negative acceleration) at the after-mentioned filtering process.

It is preferable to normalize at least any one of the reference acceleration value Gx_{acc} and the reference deceleration value Gx_{brk}. As described, an actual deceleration of the running vehicle is basically larger than an actual acceleration. Therefore, the normalization is carried out to increase the reference acceleration value Gx_{acc}.

The filtering process is applied individually to the calculated reference acceleration value Gx_{acc} and reference deceleration value Gx_{brk}. For example, a filtering is applied to the reference acceleration value Gx_{acc} using a low-pass filter expressed by the following transfer function:

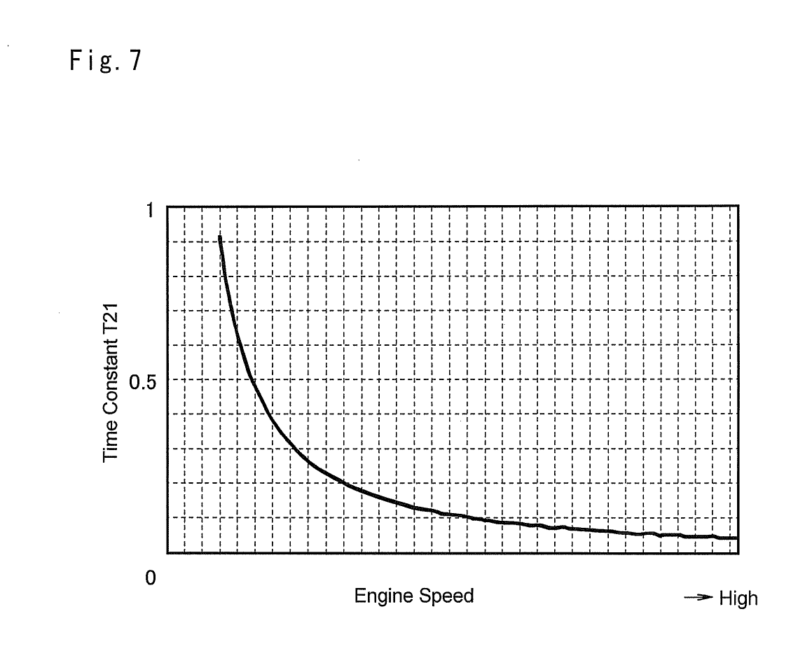

f(s)=1/(1+s·T₂₁)

where T₂₁ is a time constant determined taking into consideration a response delay of the engine 8 with respect to an operation of the accelerator carried out by the driver (Block B3). Specifically, the time constant T21 may be set according to the speed of the engine 6 with reference to the map shown in FIG. 7.

At the same time, a filtering is also applied to the reference deceleration value Gx_{brk} using a low-pass filter expressed by the following transfer function:

f(s)=1/(1+s·T₂₂)

where T₂₂ is a time constant determined taking into consideration a response delay of the braking device with respect to an operation of the braking device carried out by the driver (Block B4).

As described, if an abrupt braking or accelerating operation is executed by the driver, the reference acceleration value Gx_{acc} and the reference deceleration value Gx_{brk} are fluctuated a lot temporarily. Consequently, a noise content of high frequency is generated. However, such a noise content of high frequency contained in the longitudinal acceleration resulting from an abrupt braking or accelerating operation of the driver can be eliminated by thus carrying out the filtering of the reference acceleration value Gx_{acc} and the reference deceleration value Gx_{brk} using the low-pass filter (or a high-cut filter).

Then, a provisional target value Gx′ of the longitudinal acceleration is calculated based on the filtered acceleration and deceleration (Block B5). Specifically, the provisional target value Gx′ of the longitudinal acceleration is calculated by subtracting the filtered value of reference deceleration value Gx_{brk} from the filtered value of reference acceleration value Gx_{acc}, as expressed by the following expression:

Gx′=Gx_{acc}−Gx_{brk}.

Meanwhile, a reference lateral acceleration value Gy_{yaw} is calculated based on a steering angle of the steering wheel 16 (Block B6). The reference lateral acceleration value Gy_{yaw} is to be used as a reference value of the static lateral acceleration at the after-mentioned filtering process. Specifically, the reference lateral acceleration value Gy_{yaw} is calculated using the following formula:

Gy_{yaw}=G_{δ}^{r}(0)·(1+Tᵣ·s)/(1+2·ζ·s/ωₙ+s²/ωₙ).

In the above formula, “ωₙ” is a natural frequency of secondary oscillating system of the vehicle 1, “ζ” is a damping coefficient, “G_{δ}^{r}(0)” is a frequency transfer function, and “Tᵣ” is a time constant. Specifically, the natural frequency ωₙ can be expressed by the following expression:

ωₙ={2·(K_{f}+Kᵣ)/(m·V)}·(l_{f}·lᵣ/k²)^{1/2}·(1+S·V²)^{1/2};

the damping coefficient ζ can be expressed by the following expression:

ζ={1+k²/(l_{f}·lᵣ)}/[2·{k²/(l_{f}·lᵣ)}^{1/2}·(1+S·V²)^{1/2}];

the frequency transfer function G_{δ}^{r}(0) can be expressed by the following expression:

G_{δ}^{r}(0)={1/(1+S·V²)}·V/l; and

the time constant Tᵣ can be expressed by the following expression:

Tᵣ=m·l_{f}·V/(2·l·kᵣ).

In the above expressions, “m” is an inertial mass of the vehicle 1, “k” is a radius of yaw inertia, “V” is a vehicle speed, “l” is a wheelbase, “l_{f}” is a distance between the gravity center and a front axle of the vehicle, “lᵣ” is a distance between the gravity center and a rear axle of the vehicle, “K_{f}” is a cornering power of the front wheel 2, “Kᵣ” is a cornering power of the rear wheel 3, and “S” is a stability factor representing a control stability of the vehicle 1.

Then, a filtering is applied to the reference lateral acceleration value Gy_{yaw} using a low-pass filter expressed by the following transfer function:

f(s)=1/(1+s·T₂₃)

where T₂₃ is a time constant determined taking into consideration a response delay of the steering mechanism 15 with respect to a steering operation of the driver (Block B7). The lateral acceleration thus filtered is used as a provisional target value Gy′ of the lateral acceleration.

As the case of the reference acceleration value Gx_{acc} and the reference deceleration value Gx_{brk}, if an unintentional steering operation is executed by the driver, the reference lateral acceleration value Gy_{yaw} is also fluctuated a lot temporarily. Consequently, a noise content of high frequency is also generated. However, such noise content of high frequency contained in the lateral acceleration resulting from an unintentional steering operation of the driver can be eliminated by thus carrying out the filtering of the reference lateral acceleration value Gy_{yaw}, using the low-pass filter (or a high-cut filter).

Then, in order to obtain a target value Gx′_{filt} of the longitudinal acceleration and a target value Gy′_{filt} of the lateral acceleration, the filtering is further applied individually to the provisional target value Gx′ of the longitudinal acceleration and the provisional target value Gy′ of the lateral acceleration thus obtained.

Specifically, as shown in FIG. 6, a filtering is further applied to the provisional target value Gx′ of the longitudinal acceleration using a low-pass filter expressed by the following transfer function:

f(s)=1/(1+s·T₂₄)

where T₂₄ is a time constant determined taking into consideration a pitching resonance frequency of the behavior of the vehicle 1 in the pitching direction (Block B8). The longitudinal acceleration thus further filtered is used as the target value Gx′_{filt}.

At the same time, a filtering is further applied to the provisional target value Gy′ of the lateral acceleration using a low-pass filter expressed by the following transfer function:

f(s)=1/(1+s·T₂₅)

where T₂₅ is a time constant determined taking into consideration a rolling resonance frequency of a behavior of the vehicle 1 in the rolling direction (Block B9). The lateral acceleration thus further filtered is used as the target value Gy′_{filt}.

Thus, the vehicle 1 has intrinsic resonant frequencies in both pitching and rolling directions that is governed by the rigidity of the body of the vehicle 1, the damping characteristic of the suspension 4, the response characteristic of the steering mechanism 15 and so on. Therefore, when an unintentional braking or steering operation is carried out by the driver, resonances are caused in the rolling direction and pitching direction of the vehicle 1. Consequently, high-frequency noises are generated in both longitudinal and lateral directions of the vehicle 1. However, such high-frequency noise content can be removed by thus carrying out the filtering of the provisional target value Gx′ and Gy′ of the accelerations in both longitudinal and lateral directions, using the low-pass filters (or the high cut filters) determined taking into consideration the pitching and rolling resonance frequencies.

Then, the instant SPI is calculated based on the target value Gx′_{filt} of the longitudinal acceleration and the target value Gy′_{filt} of the lateral acceleration thus calculated (Block B10). Specifically, according to the present invention, the instant SPI is calculated by assigning the target value Gx′_{filt} of the longitudinal acceleration and the target value Gy′_{filt} of the lateral acceleration to the above-explained formula, as expressed by the following modified formula:

Instant SPI=(Gx′_{filt}²+Gy′_{filt}²)^{1/2}.

After that, the command SPI is determined based on the instant SPI thus filtered to remove the noise content by the forgoing procedures.

Thus, the noise content resulting from the accelerating and steering operations carried out not especially to enhance the sportiness can be removed by carrying out the filtering of the reference acceleration values Gx_{acc} and Gx_{brk}, and the reference lateral acceleration value Gy_{yaw}. As a result, an accuracy of estimating the driving preference of the driver can be improved. However, if a braking operation is carried out when the vehicle travels in a straight line, especially when running at a high speed, the longitudinal acceleration Gx is changed significantly in the decelerating direction even if the operating amount is small. Therefore, greater noise content would be generated by the fluctuation in the acceleration resulting from the braking operation of the case in which the vehicle travels in a straight line, in comparison with the case in which the acceleration is fluctuated by an accelerating operation or a steering operation. Consequently, the disturbance component may be contained in the acceleration data. According to the present invention, such braking operation carried out under the condition that the vehicle 1 travels in a substantially straight line is called a “straight-line braking”.

In order to avoid such a disadvantage, the vehicle control system of the present invention is configured to damp the reference deceleration value Gx_{brk} most heavily by the above-explained filtering process when the straight-line braking of the vehicle 1 is carried out, in comparison with the reference acceleration value Gx_{acc} and the reference lateral acceleration value Gy_{yaw}.

Specifically, the reference deceleration value Gx_{brk} can be damped heavily by reducing a cutoff frequency of the low-pass filter used to carry out the filtering of the reference deceleration value Gx_{brk}. Especially, the reference deceleration value Gx_{brk} can be damped to a maximum extent, that is, the fluctuation component of the reference deceleration value Gx_{brk} can be reduced to zero by reducing the cutoff frequency to zero.

For example, degree of damping the reference deceleration value Gx_{brk} may be determined based on an amount or time of the straight-line braking of the vehicle 1. Instead, the reference deceleration value Gx_{brk} may also be damped strongly to a predetermined level when the straight-line braking of the vehicle 1 is carried out. Alternatively, the degree of damping the reference deceleration value Gx_{brk} may also be maximized by setting the cutoff frequency to zero, as described. Further, the degree of damping the reference deceleration value Gx_{brk} may also be determined in accordance with the speed of the vehicle 1 when the straight-line braking is carried out.

Thus, when determining the instant SPI upon which the command SPI is based, the vehicle control system of the present invention carries out the filtering of the reference acceleration values Gx_{acc} and Gx_{brk}, and the reference lateral acceleration value Gy_{yaw} for the purpose of removing the noise content and the disturbance component resulting from an unintentional operation of the driver. In this situation, if the straight-line braking of the vehicle 1 is carried out, the reference deceleration value Gx_{brk} is damped heavier in comparison with the normal situation and in comparison with the reference acceleration values Gx_{acc} and the reference lateral acceleration value Gy_{yaw}. Therefore, the noise content and the disturbance component can be reduced even when the straight-line braking is carried out, that is, even under the condition where the noise content and the disturbance component is easily generated in the fluctuation component of the acceleration. In other words, the disturbance component contained in the acceleration information such as the reference acceleration values Gx_{acc} and Gx_{brk}, and the reference lateral acceleration value Gy_{yaw} are removed therefrom. Especially, the disturbance component is removed significantly from the reference deceleration value Gx_{brk} resulting from the braking operation. Therefore, the instant SPI and the command SPI can be determined properly so that the accuracy for estimating the driving preference of the driver can be improved.

The driving characteristics of the vehicle 1 is changed in accordance with a change in the index representing the acceleration, and the driving force and the turning performance are changed in accordance with the change in the driving characteristics. Meanwhile, the behaviors of the vehicle 1 are also changed by operating the pedals and the steering wheel. Therefore, the drivability of the vehicle 1 can be further improved by controlling those changes in the behaviors in a cooperative manner.

In addition, in order to further reduce an estimation error of driving preference of the driver, the vehicle control system of the present invention is configured to inhibit a changing control of the driving characteristics of the vehicle 1 in case the straight-line braking of the vehicle 1 is carried out. As described, if a braking operation is carried out when the vehicle travels in a substantially straight line, especially when running at a high speed, the longitudinal acceleration Gx is fluctuated significantly in the decelerating direction. Therefore, an error in calculating the instant SPI and the command SPI would be larger when the straight-line braking is carried out, in comparison with the calculation error of the case in which other kinds of operation such as the accelerating or steering operation is carried out. Therefore, an accuracy of estimating the driving preference of the driver would be deteriorated under the condition where the straight-line braking of the vehicle 1 is carried out. In this case, the intention or preference of the driver may not be reflected properly on the control for changing the driving characteristics to be carried out based on the command SPI. In order to avoid such a disadvantage, the vehicle control system of the present invention is configured to determine whether or not the straight-line braking of the vehicle 1 is carried out. In case the straight-line braking is carried out, the vehicle control system inhibits to carry out the control for changing the driving characteristics of the vehicle 1.

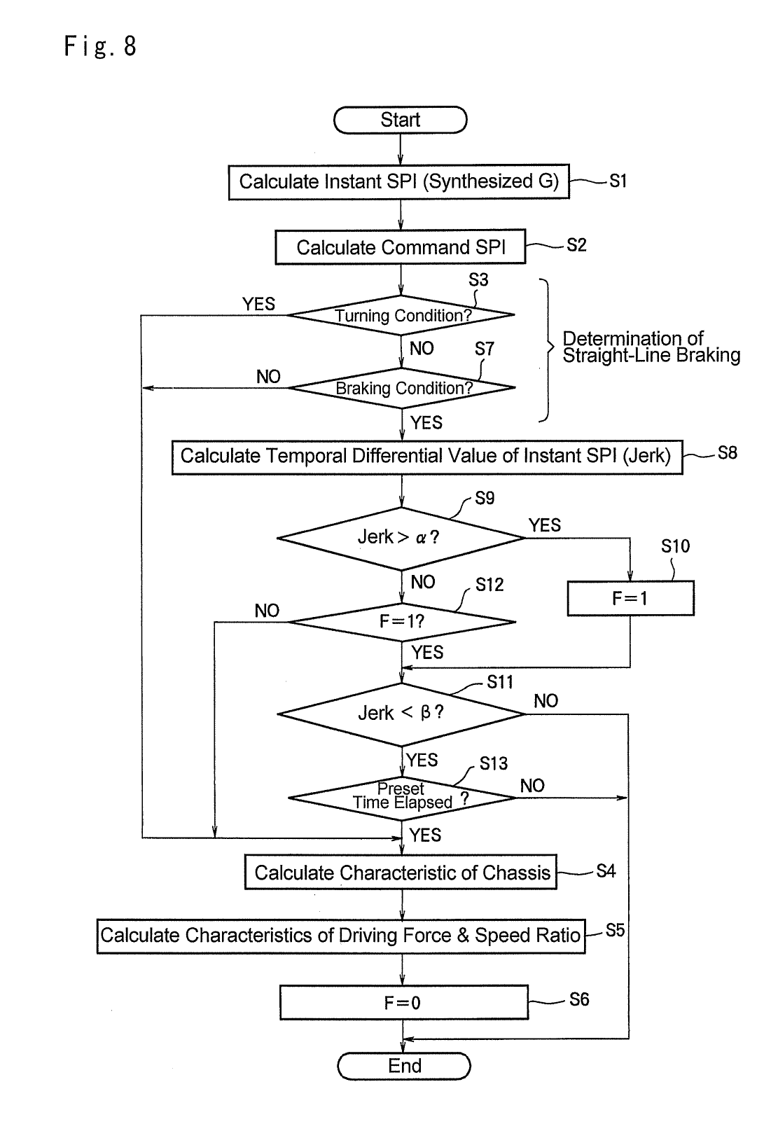

Referring now to FIG. 8, there is shown a flowchart for explaining an example of above-explained control, and the routine shown therein is carried out repeatedly at predetermined intervals. First of all, the instant SPI as the synthesized acceleration (i.e., synthesized G) is calculated (at step S1), and the command SPI is calculated based on the calculated instant SPI (at step S2). Then, it is determined whether or not the vehicle 1 is in a turning condition (at step S3). Specifically, the vehicle 1 is judged as in the turning condition if the lateral acceleration Gy as the current instant SPI falls within a turning region in the above-explained tire friction circle shown in FIG. 2 where a percentage of the lateral acceleration Gy is relatively large.

More specifically, in the friction circle shown in FIG. 2, the turning region corresponds to the regions where the percentage of component of the lateral acceleration Gy satisfies the following inequality expressions:

−A>Gy, and Gy<A

where the predetermined value “A” is a positive real number that is a threshold value determined to decide that the vehicle 1 is not turning, that is, to decide that the vehicle 1 travels in a substantially line.

Provided that the vehicle 1 travels in a substantially straight line, the lateral acceleration Gy generated by a steering operation will fall within a predetermined small range around zero where the lateral acceleration Gy will not disturb a control of the vehicle 1. Therefore, such range of the lateral acceleration Gy is used to determine the fact that the vehicle 1 travels in a substantially straight line.

Otherwise, it is also possible to decide that the vehicle 1 travels in a substantially straight line based on a fact that steering angle of the running vehicle 1 falls within a predetermined small range around zero. Such range of the steering angle may be determined in such a manner that the lateral acceleration Gy will not disturbs a control of the vehicle 1 if the steering angle of the running vehicle 1 falls within this predetermined range. Specifically, at step S3, if the lateral acceleration Gy falls within the range expressed by the following inequality expression:

−A≦Gy≦A,

where “A” is the above-mentioned predetermined value, the steering angle is considered as falling within the predetermined range.

Thus, if the value of the lateral acceleration Gy falls within any of the regions in the friction circle of FIG. 2 expressed by the above-explained inequality expressions “−A>Gy” and “Gy<A”, the vehicle 1 is judged as being in the turning condition. In other words, if the value of the lateral acceleration Gy falls within the range “−A≦Gy≦A”, the vehicle 1 is judged as travelling in a substantially straight line.

If the vehicle is in the turning condition, specifically, if the value of the lateral acceleration Gy falls within any of the regions in the friction circle of FIG. 2 expressed by the above-explained inequality expressions “−A>Gy” and “Gy<A” so that the answer of step S3 is YES, a characteristic of the chassis is calculated (at step S4), and then, characteristics of the driving force and the speed ratio are calculated (at step S5). That is, in this case, the control for changing the driving characteristics of the vehicle 1 is carried out based on the command SPI as in the normal situation. Here, the calculations of steps S4 and S5 are examples of the calculations to be carried out for changing the driving characteristics.

Thus, if the vehicle is in condition to make a turn, that is, if the answer of step S3 is YES, the lateral acceleration Gy greater than the predetermined value “A” is generated in any of the positive (e.g., to the left) and negative (e.g., to the right) directions. In case the vehicle 1 does not travel in the straight line, the controls for changing the driving characteristics of the vehicle 1 will not be inhibited, and carried out based on the command SPI as in the normal situation.

After calculating the driving characteristics of the vehicle 1 such as the characteristics of chassis, driving force, speed ratio etc. at steps S4 and S5, a flag F is set to “0” (at step S6), and the routine is ended. The flag F is initially set to “0” in the beginning of the control, and maintained to “0” until a jerk exceed the after-mentioned inhibition threshold α. Therefore, the flag F will not be changed at step S6 during a period from the beginning of the control to a point at which the jerk exceeds the inhibition threshold α. Accordingly, in case a change in the acceleration is relatively small so that the jerk is smaller than the inhibition threshold α, the driving characteristics of the vehicle is changed based on the command SPI determined based on the current acceleration, as in the normal situation.

In contrast, if the vehicle 1 is not in the turning condition and travels in a substantially straight line, specifically, if the value of the lateral acceleration Gy of the vehicle 1 falls within the range of “−A≦Gy≦A” in the friction circle shown in FIG. 2 so that the answer of step S3 is NO, the routine advances to step S7 to determine whether or not the vehicle 1 is in a braking condition. If the vehicle 1 is in the braking condition, the longitudinal acceleration Gx is generated in the decelerating direction by a braking operation within a predetermined region in the friction circle shown in FIG. 2. Therefore, the vehicle 1 is judged as being in the braking condition if the value of the longitudinal acceleration Gx falls within the range of

Gx≦0

in the friction circle shown in FIG. 2

If the value of the longitudinal acceleration Gx does not fall within the range of Gx≦0 in the friction circle shown in FIG. 2, in other words, the value of the longitudinal acceleration Gx is GX>0, the vehicle 1 is judged at step S7 as not being in the braking condition. In this case, the routine advances to step S4 as the case in which the answer of step S3 is YES. Then, the controls of steps S4, S5 and S6 are carried out sequentially. That is, the controls for changing the driving characteristics of the vehicle 1 will be carried out based on the command SPI as in the normal situation, and then, the routine is ended.

In case the answer of step S7 is NO, the longitudinal acceleration Gx is generated on the vehicle 1 in the forward direction (i.e., in the accelerating direction). This means that the straight-line braking operation is not being carried out. In this case, therefore, the controls for changing the driving characteristics of the vehicle 1 will not be inhibited and carried out based on the command SPI as in the normal situation.

In contrast, the value of the longitudinal acceleration Gx falls within the range of Gx≦0 in the friction circle shown in FIG. 2, that is, if the vehicle 1 is in the braking condition so that the answer of step S7 is YES, this means that the straight-line braking is in execution. In this case, and the routine advances to step S8 to calculate a temporal differential value of the instant SPI (i.e., a jerk) using the following formula:

Jerk={(dGx/dt)²+(dGy/dt)²}^{1/2}.

After calculating the jerk, it is determined whether or not the calculated jerk is larger than the inhibition threshold α (at step S9). Specifically, the inhibition threshold α is the smallest value of the jerk that is considered unfavorable to change the driving characteristics to change a behavior of the vehicle 1 under a situation where the acceleration is thus changing. Such smallest value of the jerk is determined based on a result of an experimentation or simulation. It is possible to use a common inhibition threshold α to judge the value of the jerk for the entire driving characteristics of the vehicle 1. Alternatively, it is also possible to set the inhibition threshold α for each factor determining the driving characteristics of the vehicle 1 such as the driving force, the speed ratio, the steering, the suspension (including the damper and the spring) and so on. In this case, the inhibition threshold α for the factor whose change is easily perceived by the driver is set to a smaller value than that of the inhibition threshold α for the other factors. Consequently, the factor whose change is easily perceived by the driver is strongly restricted to be changed while the acceleration is changing. In addition, a value of the inhibition threshold α may be not only a constant but also a variable that is changed depending on other factor such as a vehicle speed.

If the jerk is larger than the inhibition threshold α so that the answer of step S9 is YES, the flag F is set to “1” (at step S10). Then, it is determined whether or not the jerk is smaller than a permission threshold β (at step S11). The permission threshold β is a criterion value for judging whether or not the value of the jerk drops to such an extent that the control for changing the driving characteristics is allowed to be started. Specifically, the permission threshold β is set to a value of the jerk at which the driving characteristics is allowed to be changed with no problem even under the situation where the acceleration is changing. In other words, the permission threshold β is used to determine a timing to terminate the control for changing the driving characteristics under the condition that the acceleration is substantially unchanged. To this end, the permission threshold β is also determined based on a result of an experimentation or simulation.

It is also possible to use a common permission threshold β is to judge the value of the jerk for the entire driving characteristics of the vehicle 1. Likewise, it is also possible to set permission threshold β for each factor determining the driving characteristics of the vehicle 1 such as the driving force, the speed ratio, the steering, the suspension (including the damper and the spring) and so on. In this case, the permission threshold β for the factor whose change is easily perceived by the driver is set to a smaller value than that of the permission threshold β for the other factors. Consequently, the factor whose change is easily perceived by the driver is strongly restricted to be changed while the acceleration is changing. In addition, a value of the permission threshold β may be set to a constant value, e.g., to a value almost zero. Alternatively, if the value of the jerk is larger than the inhibition threshold α, the value of the permission threshold β may be set to the maximum value of the jerk. That is, the permission threshold β may be increased in accordance with an increase in the jerk.

When the flag F is set to “1”, or just after setting the flag F to “1”, the jerk is increased and it will not fall below the permission threshold β. In this situation, therefore, the answer of step S11 will be NO and the routine is ended. That is, in case the jerk is thus larger than the inhibition threshold α, the control for changing the driving characteristics is inhibited even if a large acceleration is generated so that the condition to change the driving characteristics is satisfied. In other words, the control for changing the driving characteristics of the vehicle 1 based on the command SPI is inhibited.

In contrast, if the value of the jerk is smaller than the inhibition threshold α so that the answer of step S9 is NO, it is determined whether or not the flag F is set to “1” (at step S12). If the jerk is thus smaller than the inhibition threshold α, there are two kinds of situations are conceivable. For example, the jerk may not have exceeded the inhibition threshold α in spite of being increased. Otherwise, the jerk may have fallen below the inhibition threshold α after exceeding the inhibition threshold α. If the jerk has not exceeded the inhibition threshold α, the flag F has not yet been set to “1” so that the answer of step S12 will be NO. In this case, therefore, the routine advances to carry out the controls of steps S4, S5 and S6. That is, the control for changing the driving characteristics is carried out based on the command SPI as in the normal situation, and then the routine shown in FIG. 8 is ended.

Meanwhile, if the flag F has been set to “1” so that the answer of step S12 is YES, the routine advances to step S11 to determine whether or not the jerk is smaller than the permission threshold β. As described, the permission threshold β may be set to the prior (local) maximum value of the jerk, and if so, the value of the permission threshold β may be larger than the value of the inhibition threshold α. Therefore, if the value of the jerk is still larger than the permission threshold βin spite of starting to decrease, the answer of step S11 will be NO and the routine is ended. That is, the inhibition of the control for changing the driving characteristics based on the command SPI is continued.

To the contrary, if the jerk falls below the permission threshold β so that the answer of step S11 is YES, the routine advances to step S13 to determine whether or not a preset time has elapsed. Specifically, the preset time is a latency time from a point of the affirmative determination at step S11, and a length of the preset time is determined in a manner such that the controls for changing the driving characteristics are allowed to be started or terminated under the condition in which the jerk is substantially zero. This preset time is also determined based on a result of an experimentation or simulation. In addition, the preset time may be set to a constant value. Alternatively, the preset time may be set individually for each factor governing the driving characteristics to comply with the characteristic of those factors. Otherwise, the preset time may also be set in accordance with the previous maximum value of the jerk.

If the preset time has not yet elapsed, a condition to terminate the inhibition (or restriction) of the control for changing the driving characteristics will not be satisfied. In this case, therefore, the answer of step S13 will be NO, and the routine shown in FIG. 8 is ended without carrying out any specific control.

In contrast, if the preset time has elapsed so that the answer of step S13 is YES, the routine advances to carry out the controls of steps S4, S5 and S6. That is, the control for changing the driving characteristics is carried out based on the command SPI as in the normal situation, and then the routine shown in FIG. 8 is ended. If the inhibition threshold α and the permission threshold β are set individually for each factor governing the driving characteristics, the characteristic of each factor is changed individually when the jerk falls below the permission threshold β thereof. If the permission threshold β is set to the prior maximum value of the jerk, a commencement of the control for changing the driving characteristic is hastened, and the driving characteristics are changed after the preset time has elapsed since the jerk falls below the permission threshold β. Therefore, the control for changing the driving characteristics is completed under the condition in which the jerk is substantially zero. In other words, the permission threshold β or the preset time is determined in such a manner that the control for changing the driving characteristics is terminated under the condition in which the jerk is substantially zero.

Thus, according to the control example shown in FIG. 8, if the straight-line braking of the vehicle 1 is carried out, the control for changing the driving characteristics based on the command SPI is inhibited while the jerk as a temporal differential value of the instant SPI is larger than the threshold value. Specifically, if the straight-line braking of the vehicle 1 is commenced, the control for changing the driving characteristics based on the command SPI is inhibited until the acceleration resulting from the straight-line braking is stabilized, that is, until the jerk falls below the threshold value. Therefore, even if the acceleration is disturbed significantly by the straight-line braking, the command SPI can be prevented from being disturbed by the straight-line braking. This means that the driving characteristics will not be changed against the driver's intension during the straight-line braking. For this reason, accuracy for estimating the driving preference of the driver can be improved and the control for changing the driving characteristics of the vehicle 1 can be carried out properly.

As described, the inhibition threshold α and the permission threshold β can be set individually for each factor governing the driving characteristics. Therefore, an order to commence the control for changing the characteristic of those factors can be decided based on the values of those thresholds. In addition, the control for changing the driving characteristics can be commenced after a time lag. In case of carrying out the controls for changing the driving characteristics in order or after a lag, the control for changing the characteristic of the chassis can be commenced prior to carry out the control for changing the characteristic of the driving force. Alternatively, the characteristic of the factor whose response is quick can be changed in advance.

According to the present invention, the vehicle control system is configured to adjust the characteristics of the following factors, such as: the driving force generated by the engine 8; the damping force of the suspension; the stabilizer; the steering force of the steering mechanism; the differential; the vehicle height; the engine mount; the braking force; the aerodynamic; the color indication; the acoustic effect in the vehicle interior and so on.

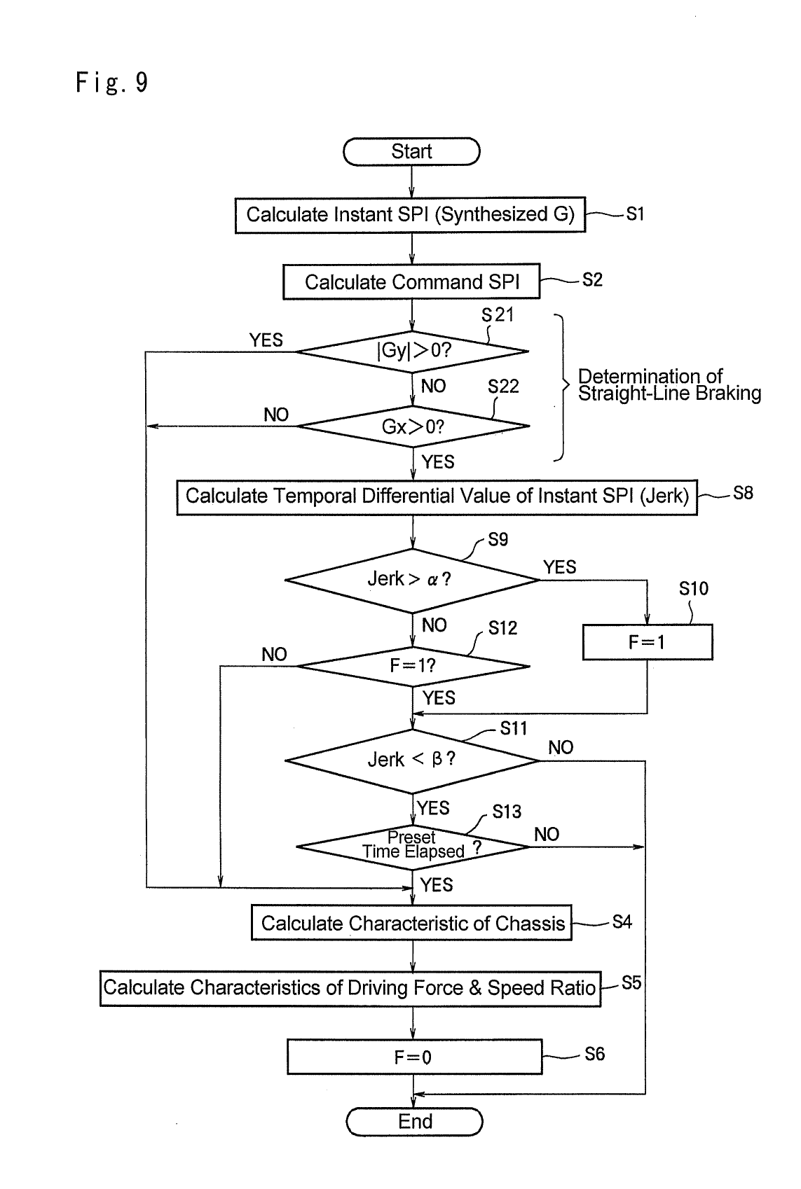

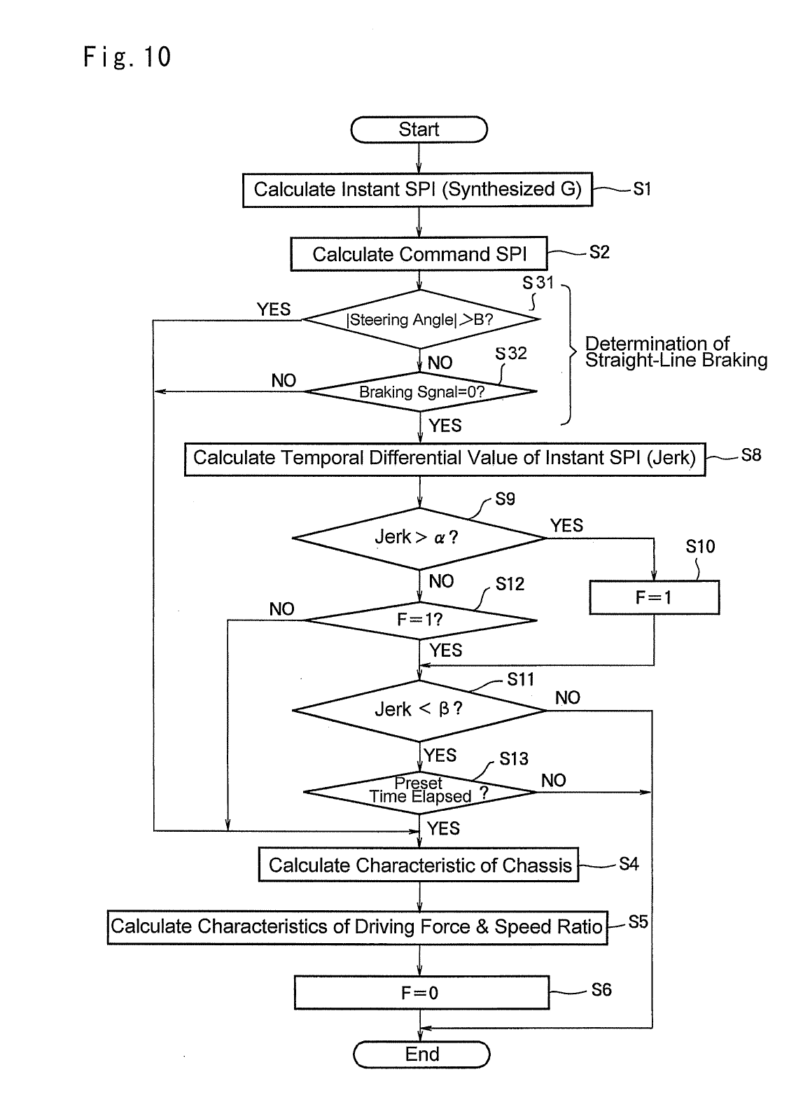

Thus, according to the control example shown in FIG. 8, the turning condition of the vehicle 1 is determined at step S3, and an execution of the braking operation of the vehicle 1 determined at step S7. That is, an execution of the braking operation under the situation where the vehicle 1 travels in a substantially straight line is judged at step S3 and S7. Such determination of the straight-line braking can be modified as shown in FIGS. 9 and 10.

Referring now to FIG. 9, there is shown another example of the determination of the straight-line braking. As the example shown in FIG. 8, the instant SPI is calculated (at step S1), and the command SPI is calculated based on the instant SPI (at step S2). Then, the determination of the straight-line braking is carried out at steps S21 and S22. Specifically, it is determined whether or not an absolute value of the lateral acceleration Gy of the vehicle 1 is larger than zero (at step S21).

If the absolute value of the lateral acceleration Gy is larger than zero so that the answer of step S21 is YES, the routine advances to steps S4 and S5 to calculate the characteristic of the chassis, and to calculate the characteristics of the driving force and the speed ratio. That is, the control for changing the driving characteristics is carried out based on the command SPI as in the normal situation, and then the routine shown in FIG. 9 is ended.

If the answer of step S21 is YES, this means that the lateral acceleration Gy is generated in any of the positive (e.g., to the left) and negative (e.g., to the right) directions. That is, the vehicle 1 is making a turn. In case the vehicle 1 does not travel in the straight line, the controls for changing the driving characteristics of the vehicle 1 will not be inhibited, and carried out based on the command SPI as in the normal situation.

In contrast, if the absolute value of the lateral acceleration Gy is not larger than zero, that is, if the lateral acceleration Gy is zero so that the answer of step S21 is NO, the routine advances to step S22 to determine whether or not the longitudinal acceleration Gx is larger than zero. That is, it is determined whether or not the longitudinal acceleration Gx is generated on the vehicle 1 in the forward direction (i.e., in the accelerating direction).

If the longitudinal acceleration Gx is larger than zero, that is, if the longitudinal acceleration Gx is generated on the vehicle 1 in the forward direction so that the answer of step S22 is YES, the routine also advances to step S4 to carry out the controls of steps S4, S5 and S6 sequentially, as in the case that the answer of step S21 is YES. That is, the control for changing the driving characteristics is carried out based on the command SPI as in the normal situation, and then the routine shown in FIG. 9 is ended.

If the answer of step S22 is YES, this means that the longitudinal acceleration Gx is generated in the accelerating direction. That is, the straight-line braking of the vehicle 1 is not carried out in this situation. In this case, therefore, the controls for changing the driving characteristics of the vehicle 1 will not be inhibited, and carried out based on the command SPI as in the normal situation.

In contrast, if the longitudinal acceleration Gx is smaller than zero so that the answer of step S22 is NO, the routine advances to step S8 to calculate a temporal differential value of the instant SPI (i.e., the jerk). According to the control example shown in FIG. 9, the remaining steps other than the above-explained steps S21 and S22 are identical to those of the control example shown in FIG. 8. Therefore, detailed explanation for those common steps will be omitted.

If the answer of steps S21 is NO, this means that the lateral acceleration Gy is not generated on the vehicle 1, and if the answer of steps S22 is NO, this means that the longitudinal acceleration Gx is generated on the vehicle 1 in the backward direction (i.e., in the decelerating direction). In this situation, specifically, the vehicle 1 travels in a substantially straight line, and a braking operation is carried out. That is, the straight-line braking is carried out. In this case, therefore, the routine advances to step S8, and the control for changing the diving characteristics of the vehicle 1 based on the command SPI is inhibited as the example shown in FIG. 8. Therefore, even if the acceleration is disturbed significantly by the straight-line braking, the command SPI can be prevented from being changed by the disturbance resulting from the straight-line braking. This means that the driving characteristics will not be changed against the driver's intension during the straight-line braking. For this reason, accuracy for estimating the driving preference of the driver can be improved and the control for changing the driving characteristics of the vehicle 1 can be carried out properly.

Referring now to FIG. 10, there is shown still another example of the determination of the straight-line braking. As the example shown in FIG. 8, the instant SPI is calculated (at step S1), and the command SPI is calculated based on the instant SPI (at step S2). Then, the determination of the straight-line braking is carried out at steps S31 and S32. Specifically, it is determined whether or not an absolute value of a steering angle of the vehicle 1 achieved by the driver is larger than a predetermined value “B” (at step S31). The predetermined value “B” is a threshold value used to determine whether or not the vehicle 1 travels in a substantially straight line, when determining execution of the straight-line braking. To this end, the predetermined value “B” is set to a relatively small value close to zero degree. Accordingly, if the absolute value of the steering angle is smaller than the predetermined value “B”, the vehicle 1 is judged as travelling in the substantially straight line.

If the absolute value of the steering angle is larger than the predetermined value “B” so that the answer of step S31 is YES, the routine advances to steps S4 and S5 to calculate the characteristic of the chassis, and to calculate the characteristics of the driving force and the speed change. That is, the control for changing the driving characteristics is carried out based on the command SPI as in the normal situation, and then the routine shown in FIG. 10 is ended.

If the answer of step S31 is YES, this means that the vehicle 1 is not travelling in a straight line, that is, the vehicle 1 is making a turn. In this case, therefore, the controls for changing the driving characteristics of the vehicle 1 will not be inhibited, and carried out based on the command SPI as in the normal situation.

In contrast, if the absolute value of the steering angle is smaller than the predetermined value “B” so that the answer of step S31 is NO, the routine advances to step S32 to determine whether or not a braking operation of the vehicle 1 is carried out by the driver, that is, to determine whether or not a braking signal is “ON”. Specifically, the braking signal is an ON-OFF signal of a brake switch (not shown) activated in conjunction with the brake pedal 7. For example, if the brake pedal 7 is operated (depressed), the brake switch is turned on and the signal indicating “ON” is outputted. By contrast, when the brake pedal 7 is returned, the brake switch is turned off and the signal indicating “OFF” is outputted.

If the braking signal is “OFF” so that the answer of step S32 is NO, the routine also advances to step S4 to carry out the controls of steps S4, S5 and S6 sequentially, as in the case that the answer of step S31 is YES. That is, the control for changing the driving characteristics is carried out based on the command SPI as in the normal situation, and then the routine shown in FIG. 10 is ended.

If the answer of step S32 is NO, this means that the braking operation of the vehicle 1 is not carried out so that the brake switch is turned off. That is, the straight-line braking of the vehicle 1 is not carried out in this situation. In this case, therefore, the controls for changing the driving characteristics of the vehicle 1 will not be inhibited, and carried out based on the command SPI as in the normal situation.

In contrast, if the braking signal is “ON” so that the answer of step S32 is YES, the routine advances to step S8 to calculate a temporal differential value of the instant SPI (i.e., the jerk). According to the control example shown in FIG. 10, the remaining steps other than the above-explained steps S31 and S32 are identical to those of the control example shown in FIG. 8. Therefore, detailed explanation for those common steps will be omitted.

If the answer of steps S31 is NO, this means that the steering angle is substantially zero, and if the answer of steps S32 is YES, this means that the braking signal is “ON”. In this situation, specifically, the vehicle 1 travels in a substantially straight line, and a braking operation is carried out. That is, the straight-line braking is carried out. In this case, therefore, the routine advances to step S8, and the control for changing the diving characteristics of the vehicle 1 based on the command SPI is inhibited as the example shown in FIG. 8. Therefore, even if the acceleration is disturbed significantly by the straight-line braking, the command SPI can be prevented from being changed by the disturbance resulting from the straight-line braking. This means that the driving characteristics will not be changed against the driver's intension during the straight-line braking. For this reason, accuracy for estimating the driving preference of the driver can be improved and the control for changing the driving characteristics of the vehicle 1 can be carried out properly.

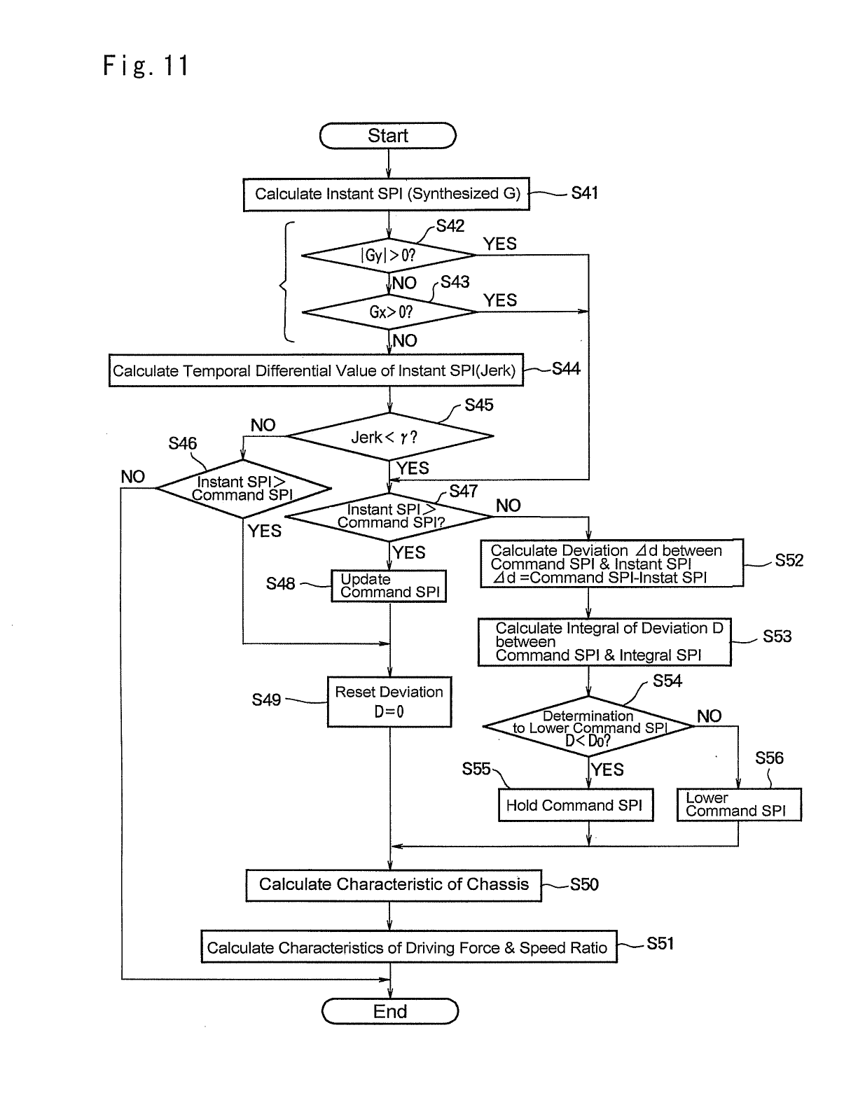

Referring now to FIG. 11, there is shown a flowchart for explaining another control example of the present invention, and the routine shown therein is also carried out repeatedly at predetermined intervals. As the example shown in FIG. 8, first of all, the instant SPI as the synthesized acceleration (i.e., synthesized G) is calculated (at step S41). Then, it is determined whether or not an absolute value of the lateral acceleration Gy of the vehicle 1 is larger than zero (at step S42).

If the absolute value of the lateral acceleration Gy is not larger than zero, that is, if the lateral acceleration Gy is zero so that the answer of step S42 is NO, the routine advances to step S43 to determine whether or not the longitudinal acceleration Gx is larger than zero. That is, it is determined whether or not the longitudinal acceleration Gx is generated on the vehicle 1 in the forward direction (i.e., in the accelerating direction).

If the longitudinal acceleration Gx is smaller than zero so that the answer of step S43 is NO, the routine advances to step S44 to calculate a temporal differential value of the instant SPI (i.e., the jerk).

If the answer of steps S42 is NO, this means that the lateral acceleration Gy is not generated on the vehicle 1, and if the answer of steps S43 is NO, this means that the longitudinal acceleration Gx is generated on the vehicle 1 in the backward direction (i.e., in the decelerating direction). In this situation, specifically, the vehicle 1 travels in a substantially straight line, and a braking operation is carried out. That is, the straight-line braking is carried out. In this case, therefore, the routine advances to step S44 to calculate the jerk.

Then, it is determined whether or not the jerk calculated at step S44 is smaller than an inhibition threshold γ (at step S45). Specifically, the inhibition threshold γ is the smallest value of the jerk that is considered unfavorable to change the driving characteristics to change a behavior of the vehicle 1 under a situation where the acceleration is thus changing. Such smallest value of the jerk is determined based on a result of an experimentation or simulation. It is possible to use a common inhibition threshold γ to judge the value of the jerk for the entire driving characteristics of the vehicle 1. Alternatively, it is also possible to set the inhibition threshold γ for each factor determining the driving characteristics of the vehicle 1 such as the driving force, the speed ratio, the steering, the suspension (including the damper and the spring) and so on. In this case, the inhibition threshold γ for the factor whose change is easily perceived by the driver is set to a smaller value than that of the inhibition threshold γ for the other factors. Consequently, the factor whose change is easily perceived by the driver is strongly restricted to be changed while the acceleration is changing. In addition, a value of the inhibition threshold γ may be not only a constant but also a variable that is changed depending on other factor such as a vehicle speed.

If the jerk calculated at step S44 is larger than the inhibition threshold γ so that the answer of step S45 is NO, the routine advances to step S46 to compare the instant SPI calculated at step S41 with the current command SPI being held. That is, it is determined whether or not the instant SPI is larger than the command SPI. If the instant SPI is smaller than the command SPI so that the answer of step S46 is NO, the routine shown in FIG. 11 is ended without carrying out subsequent controls such as the control for changing the driving characteristics to be carried out at after-mentioned steps S50 and S51. That is, if the jerk is larger than inhibition threshold γ, and the instant SPI is smaller than the command SPI, the control for changing the driving characteristics is inhibited.

In contrast, if the jerk is smaller than the inhibition threshold γ so that the answer of step S45 is YES, the routine advances to step S47 to compare the instant SPI calculated at step S41 with the current command SPI being held. That is, it is determined whether or not the instant SPI is larger than the command SPI.

Meanwhile, if the absolute value of the lateral acceleration Gy is larger than zero, that is, if a predetermined magnitude of the lateral acceleration Gy is generated by a steering operation so that the answer of step S42 is YES, the foregoing steps S43, S44 and S45 are skipped and the routine advances to step S47 to determine whether or not the instant SPI is larger than the command SPI. Likewise, if the longitudinal acceleration Gx is larger than zero, that is, if the longitudinal acceleration Gx is generated on the vehicle 1 in the forward (i.e., accelerating) direction so that the answer of step S43 is YES, the routine also skips steps S44 and S45 and advances to step S47 to determine whether or not the instant SPI is larger than the command SPI.

If the instant SPI calculated at step S41 is larger than the command SPI so that the answer of step S47 is YES, the routine advances to step S48 to update the command SPI to the current value of the instant SPI. As described, a deviation between the command SPI and the instant SPI is accumulated during maintaining the command SPI to the current value. However, if the command SPI is thus updated, an integral of deviation D between the command SPI and the instant SPI is reset to zero (at step S49), as expressed by the following equation:

D=0.

Likewise, in case the jerk is larger than the inhibition threshold γ so that the answer of step S45 is NO, and the instant SPI is larger than the command SPI so that the answer of step S46 is YES, the routine skips steps S47 and S48 to carry out the reset of the integral of deviation D at step S49.

After resetting the integral of deviation D at step S49, the routine advances to steps S50 and S51 to calculate the characteristic of the chassis, and to calculate the characteristics of the driving force and the speed change. That is, the control for changing the driving characteristics is carried out based on the command SPI, and then the routine shown in FIG. 11 is ended.

In contrast, if the instant SPI calculated at step S41 is smaller than the command SPI so that the answer of step S47 is NO, the routine advances to step S52 to calculate a deviation Ad between the command SPI and the instant SPI, as expressed by the following expression:

Δd=command SPI−instant SPI.

Then, the integral of deviation D between the command SPI and the instant SPI is calculated (at step S53), as expressed by the following expression:

D=D+Δd.

After this, it is determined whether or not the integral of deviation D between the command SPI and the instant SPI is smaller than a reduction threshold D₀ (at step S54). Specifically, the reduction threshold D₀ is a threshold value determining a length of time to a commencement of lowering the command SPI being held. In other words, the reduction threshold D₀ is a threshold value determining a length of time to hold the command SPI to the current value. Therefore, the command SPI is lowered when the integral of deviation D becomes larger than the reduction threshold D₀.

Accordingly, if the integral of deviation D between the command SPI and the instant SPI is smaller than the reduction threshold D₀ so that the answer of step S54 is YES, the routine advances to step S55 to hold the command SPI to the current value. In contrast, if the integral of deviation D between the command SPI and the instant SPI is larger than the reduction threshold D₀ so that the answer of step S54 is NO, the routine advances to step S56 to lower the command SPI. In this case, the command SPI may be reduced in a manner such that the driver will not fell uncomfortable feeling.

After thus holding the command SPI to the current value, or after thus lowering the value of the command SPI, the routine advances to step S50 to carry out the controls of steps S50 and S51 sequentially. That is, the control for changing the driving characteristics is carried out based on the command SPI, and then the routine shown in FIG. 11 is ended.

Thus, according to the control example shown in FIG. 11, if the straight-line braking of the vehicle 1 is carried out, the control for changing the driving characteristics based on the command SPI is inhibited while the jerk as a temporal differential value of the instant SPI is larger than the threshold value, and the instant SPI is smaller than the command SPI. Specifically, when the straight-line braking of the vehicle 1 is detected, and the jerk at that moment is larger than the threshold value, the control for changing the driving characteristics based on the command SPI is inhibited until the instant SPI exceeds the command SPI. Therefore, even if acceleration is disturbed significantly by the straight-line braking, the command SPI can be prevented from being changed by the disturbance resulting from the straight-line braking. This means that the driving characteristics will not be changed against the driver's intension during the straight-line braking. For this reason, accuracy for estimating the driving preference of the driver can be improved and the control for changing the driving characteristics of the vehicle 1 can be carried out properly.

Thus, according to the present invention, the vehicle control system is configured to remove the disturbance resulting from the straight-line braking of the vehicle 1. Specifically, the disturbance factor resulting from the specific operation is damped strongly by the filtering using the low-pass filter, in comparison with the other operational disturbance resulting from e.g., an accelerating and a steering operation. Otherwise, the control for changing the driving characteristics of the vehicle 1 is inhibited until the change in the acceleration (i.e., deceleration) resulting from the straight-line braking of the vehicle 1 is stabilized.

Therefore, the disturbance resulting from the straight-line braking can be reduced so that the control for changing the driving characteristics can be carried out properly without being effected by the disturbance resulting from the straight-line braking. For this reason, the driving characteristics of the vehicle 1 will not be changed against the driver's intension during the straight-line braking. That is, the control for changing the driving characteristics of the vehicle 1 can be carried out properly while reflecting the driving preference of the driver accurately.

1. A vehicle control system, which is configured to estimate an index representing a driving condition of a vehicle and a driving preference of a driver based on acceleration of the vehicle, and to adjust a driving characteristics of the vehicle based on the index, comprising:
a straight-line braking determining means configured to determine a fact that a braking operation of the vehicle is carried out under a condition that the vehicle travels in a straight line; and
an operational disturbance reducing means that prevents or reduces an effect of a disturbance resulting from the straight-line braking of the vehicle on an adjustment of the driving characteristics of the vehicle.

2. The vehicle control system as claimed in claim 1,
wherein the operational disturbance reducing means includes a means configured to damp the operational disturbance resulting from the straight-line braking of the vehicle stronger in comparison with the disturbances resulting from an accelerating operation and a steering operation.

3. The vehicle control system as claimed in claim 1, wherein the operational disturbance includes:
a disturbance component contained in acceleration data of a case in which the straight-line braking is carried out, and/or
disturbance components contained in the acceleration data of a case in which the accelerating operation is carried out, and contained in the acceleration data of a case in which the steering operation is carried out.

4. The vehicle control system as claimed claim 1,
wherein the operational disturbance reducing means includes a means configured to inhibit the control for changing the driving characteristics of the vehicle when the straight-line braking of the vehicle is carried out.

5. The vehicle control system as claimed in claim 4, further comprising:
a calculation means configured to calculate a jerk as a temporal differential value of the acceleration; and
wherein the operational disturbance reducing means includes a means configured to inhibit the control for changing the driving characteristics of the vehicle while the jerk exceeds a predetermined inhibition threshold.

6. The vehicle control system as claimed claim 1,
wherein the acceleration includes a longitudinal acceleration of the vehicle and a lateral acceleration of the vehicle;
wherein the condition that the vehicle travels in a straight line includes a condition that the vehicle travels in a substantially straight line and that the lateral acceleration is within a predetermined range including zero; and
wherein the straight-line braking determining means includes a means configured to determine a fact that the straight-line braking operation is carried out based on the longitudinal acceleration and the lateral acceleration.

7. The vehicle control system as claimed claim 1, further comprising:
a steering angle detecting means that detects a steering angle of the vehicle; and
a braking operation detecting means that detects a fact that the braking operation of the vehicle is carried out;
wherein the condition that the vehicle travels in a straight line includes a condition that the vehicle travels in a substantially straight line and that the lateral acceleration is within a predetermined range including zero; and
wherein the straight-line braking determining means includes a means configured to determine a fact that the straight-line braking operation is carried out based on the steering angle and the fact that the braking operation is carried out.

8. A vehicle control system, which is configured to estimate an index representing a driving condition of a vehicle and a driving preference of a driver based on acceleration of the vehicle, and to adjust a driving characteristics of the vehicle based on the index, wherein:
the vehicle control system is configured to carry out a disturbance reducing control for preventing or reducing an effect of an operational disturbance resulting from a braking operation of the vehicle on an adjustment of the driving characteristics of the vehicle, in case the braking operation is carried out under a condition that a lateral acceleration resulting from a steering operation of the vehicle is within a predetermined range that will not effect on the adjustment of the driving characteristics so that the vehicle travels in a substantially straight line; and
the vehicle control system is configured to inhibit the control for changing the driving characteristics of the vehicle while the braking operation is carried out under the condition that the vehicle travels in the straight line so that the disturbance reducing control is carried out.
